(19) United States
(12) Patent Application Publication
(10) Pub. No.: US 2016/0116410 A1
(43) Pub. Date: Apr. 28, 2016

(54) APPARATUS AND METHOD FOR JOINT REFLECTANCE AND FLUORESCENCE SPECTRA ESTIMATION

(71) Applicant: The Board of Trustees of the Leland Stanford Junior University, Stanford, CA (US)

(72) Inventors: Henryk Blasinski, Stanford, CA (US); Brian A. Wandell, Stanford, CA (US); Joyce E. Farrell, Stanford, CA (US)

(21) Appl. No.: 14/921,907

(22) Filed: Oct. 23, 2015

Related U.S. Application Data
(60) Provisional application No. 62/068,191, filed on Oct. 24, 2014.

(51) Int. Cl. G01N 21/64; G01N 21/31; G01N 21/55

(52) U.S. Cl. CPC G01N 21/6456; G01N 21/6428; G01N 21/643; G01N 21/55; G01N 21/31; G01N 2201/12; G01N 2201/062

(57) ABSTRACT

Embodiments are directed to apparatuses and methods that jointly estimate reflectance and fluorescence spectra. An example embodiment includes providing captured intensity characteristics indicative of a target, the intensity characteristics acquired by illuminating the target with different illuminants and passing light in different spectral bands via a photodetector apparatus and providing reflectance properties and fluorescent properties of the target. The example embodiment further includes concurrently adjusting the reflectance properties and fluorescence properties to reduce a quantity indicative of a combination of: a difference between the captured intensity characteristics and intensities predicted using an image formation model incorporating the reflectance properties and fluorescence properties, functions of the reflectance properties, and functions of the fluorescence properties.

### BACKGROUND

A variety of fluorescent material is used in different fields. Such fluorescent material includes both natural and man-made material. The reflectance and fluorescence measurement of fluorescent material has biomedical and industrial applications, including measurements of living organisms, drug discovery, and manufacturing. For example, many biological molecules are intrinsically fluorescent and this property is exploited in medical imaging. Further, fluorescent compounds are present in man-made objects, such as to add a boost of color saturation. An example is white paper. While it may appear that paper is purely reflective, compounds emitting light in a shorter wavelength counteract the natural reflectance in that region. The net effect of fluorescence and reflected light results in a perceptually white surface. Similar effects are used in the textile industry as well as washing and bleaching detergents.

Due to the separation between reflected and fluoresced components, it can be difficult to distinguish between reflected and fluoresced photons. Further, measuring reflectance and fluorescence of objects can be time consuming. These and other matters have presented challenges to imaging, for a variety of applications.

### SUMMARY

Various example embodiments are directed to methods, apparatuses, systems and other aspects as discussed herein, and may involve addressing one or more of the above challenges.

One or more embodiments are directed to a method as follows. Captured intensity characteristics indicative of a target are provided, with the intensity characteristics being acquired by illuminating the target with different illuminants and passing light in different spectral bands via a photodetector apparatus. Reflectance properties and fluorescent properties of the target are provided and concurrently adjusted to reduce a quantity indicative of a combination of: a difference between the captured intensity characteristics and intensities predicted using an image formation model incorporating the reflectance properties and fluorescence properties, functions of the reflectance properties, and functions of the fluorescence properties. A reflectance spectra estimation and a fluorescent spectra estimation are output for the fluorophore, based on the adjusted reflectance properties and fluorescence properties.

Another embodiments is directed to an apparatus comprising an illumination source, a photodetector arrangement, and processing circuitry. The illumination source illuminates a target by directing a plurality of different illuminants toward the target, the plurality of different illuminants spanning a spectrum. The photodetector arrangement includes a photodetector circuit and selectively passes light in each of a plurality of different spectral bands to the photodetector circuit. The photodetector circuit captures intensity characteristics indicative of a fluorophore of the target acquired in the plurality of different spectral bands and under the plurality of different illuminations. Further, the processing resource (e.g., processing circuitry) provides reflectance properties and fluorescent properties of the target and concurrently adjusts the reflectance properties and fluorescence properties. The concurrent adjustment is to reduce a quantity indicative of a combination of: a difference between the captured intensity characteristics and intensities predicted using an image formation model incorporating the reflectance properties and fluorescence properties, functions of the reflectance properties, and functions of the fluorescence properties. Further, the processing resource outputs a reflectance spectra estimation and a fluorescent spectra estimation for the fluorophore based on the adjusted reflectance properties and fluorescence properties.

Another embodiment is directed to an apparatus including an illumination source, a photodetector arrangement, and processing circuitry. The illumination source is configured to illuminate a target by directing a plurality of different illuminants toward the target, the plurality of different illuminants spanning a spectrum. The photodetector arrangement includes a photodetector circuit and is configured to selectively pass light in each of a plurality of different spectral bands to the photodetector circuit. The photodetector circuit is configured to capture intensity characteristics indicative of a fluorophore of the target acquired in the plurality of different spectral bands and under the plurality of different illuminations. The processing circuitry processes the captured intensity characteristics as follows. For each of the different spectral bands, the captured intensity characteristics are used to provide component entries that correspond to and characterize fluorescence and reflectance contributions in each of the different spectral bands. In response to the provided component entries, components indicative of reflectance spectra estimation and fluorescence spectra estimation are concurrently computed based on the captured intensity characteristics of the selectively passed light in the different spectral bands, and based on the computed components having a smoothness function relative to adjacent ones of the different spectral bands. The processing circuitry selects, among the concurrently computing components in each of the different spectral bands, ones of the concurrently computed components that are likely to be indicative of reflectance spectra estimation and fluorescence spectra estimation for a fluorophore in the target. The reflectance spectra estimation and fluorescence spectra estimation are output for the fluorophore in the target using the selected components.

In more particular embodiments, an apparatus embodiment includes an illumination source, a photodetector arrangement, and processing circuitry. The illumination source is configured to illuminate a target by directing a plurality of different illuminants toward the target, the plurality of different illuminants spanning a spectrum. The photodetector arrangement includes a photodetector circuit, an optical filter and a lens. The optical filter is arranged in an optical path between the photodetector circuit and the target. The filter and the lens are configured to selectively pass light in each of a plurality of different spectral bands to the photodetector circuit. The photodetector circuit is configured to capture intensity characteristics indicative of a fluorophore of the target acquired in the plurality of different spectral bands and under the plurality of different illuminants. The processing circuitry is configured and arranged to process the captured intensity characteristics as follows. For each of the different spectral bands, the captured intensity characteristics are used to provide component entries that correspond to and characterize fluorescence and reflectance contributions in each of the different spectral bands. In response to the provided component entries, components indicative of reflectance spectra estimation and fluorescence spectra estimation are concurrently computed based on the captured intensity characteristics of the selectively passed light in the different spectral bands and based on the computed components having a smoothness function relative to adjacent ones of the different spectral bands. The processing circuitry selects, among the concurrently computing components in each of the spectral bands, ones of the concurrently computed components that are likely to be indicative of reflectance spectra estimation and fluorescence spectra estimation for a fluorophore in the target by minimizing a quantity indicative of a combination of: a difference between the captured intensity characteristics and the computed components, a smoothness function relative to adjacent ones of the different spectral bands, and a nuclear norm of the component entries that correspond to and characterize fluorescence contributions. The reflectance spectra estimation and fluorescence spectra estimation are output for the fluorophore in the target using the selected components.

The above discussion/overview is not intended to describe each embodiment or every implementation of the present disclosure.

### BRIEF DESCRIPTION OF THE FIGURES

Various example embodiments may be more completely understood in consideration of the following detailed description and in connection with the accompanying drawings, in which:

FIG. 1A shows an example apparatus in accordance with various embodiments;

FIG. 1B shows an example method of jointly estimating reflectance and fluorescence spectras in accordance with various embodiments;

FIG. 2 shows an example apparatus in accordance with various embodiments shown by way of example as imaging a target, in accordance with various embodiments;

FIGS. 3A-3C show an example of a normalized emission spectra of a two fluorophore sample under different monochromatic lights in accordance with various embodiments;

FIG. 4 shows a specific example of an apparatus including a particular photodetector arrangement in accordance with various embodiments;

FIGS. 5A-5B show an example of the root-mean-square error (RMSE) of the Donaldson matrix estimates using the multi-fluorophore and single fluorophore models in accordance with various embodiments;

FIGS. 6A-6B show an example of the RMSE of the Donaldson matrix estimates averaged over 10 different fluorophores using the multi-fluorophore and single fluorophore models in accordance with various embodiments;

FIGS. 7A-7B show an example of the average RMSE of the Donaldson matrix, reflectance, and pixel value estimates as a function of the signal to noise ratio (SNR) using the multi-fluorophore and single fluorophore models in accordance with various embodiments;

FIGS. 8A-8B show an example of the multi-fluorophore estimates RMSE as a function of the number of Alternating Direction Method of Multipliers (ADMM) iterations as well as the biconvex estimates RMSE as a function of the number of biconvex iterations in accordance with various embodiments;

FIGS. 9A-9D show examples of spectral properties of a target in accordance with various embodiments;

FIGS. 10A-10B show example wavelengths associated with illumination and filters of an example apparatus in accordance with various embodiments;

FIG. 11 shows an example of a collection 1113 of images acquired where a target is imaged under a specific illuminant and as seen through a filter in accordance with various embodiments;

FIGS. 12A-12D show examples of conventional red green blue (RGB) camera images of the target when illuminated with lights in different spectral bands in accordance with various embodiments;

FIG. 13 shows an example of multi-fluorophore estimation results for patches A, B and C illustrated in FIG. 11 in accordance with various embodiments;

FIG. 14 shows an example of fluoresced and reflected radiance separation and relighting in accordance with various embodiments;

FIG. 15 shows an example of the estimated reflectance and fluorescence excitation and emission spectra of path D of FIG. 11 in accordance with various embodiments;

FIG. 16A shows an example of the average RMSE for spectral reflectance, excitation and emission spectra estimates declines as the bands separate in accordance with various embodiments; and

FIG. 16B shows an example of RMSE as the practical efficiency of the fluorescent component increases in accordance with various embodiments.

While various embodiments discussed herein are amenable to modifications and alternative forms, aspects thereof have been shown by way of example in the drawings and will be described in detail. It should be understood, however, that the intention is not to limit the invention to the particular embodiments described. On the contrary, the intention is to cover all modifications, equivalents, and alternatives falling within the scope of the disclosure including aspects defined in the claims. In addition, the term “example” as used throughout this application is only by way of illustration, and not intended to limit the scope of the present disclosure.

### DETAILED DESCRIPTION

Aspects of the present disclosure are believed to be applicable to a variety of different types of apparatuses, systems and methods, including those that are designed to measure either reflectance or fluorescence spectra. In certain aspects, the apparatus and/or methods facilitate joint (including concurrent/simultaneous) estimation of both reflectance and fluorescence spectra of a target. The reflectance and fluorescence spectral properties may be utilized to define how a given surface reflects and emits light in each wavelength of a spectrum, and can provide important information about the material properties. In specific embodiments, the material properties are useful for identification or detection in a variety of fields ranging from industrial and process control through medicine and biology. While not necessarily so limited, various aspects may be appreciated through a discussion of examples using such exemplary contexts.

Materials are commonly characterized by their reflectance spectra, which describes the fraction of incident photons that are reflected at each wavelength. In addition to reflecting light, some materials absorb light in some wavelengths only to re-emit photons at other (e.g., longer) wavelengths, a phenomenon called fluorescence. Fluorescent materials, sometimes called fluorophores, are common in nature, man-made objects (e.g., paper, textiles, and displays), and biological tissues. Further, fluorophores, in nature, selectively bind to specific molecules which are useful in the biological and medical sciences. Reflectance and fluorescence of targets are estimated for a wide variety of biomedical and industrial applications, including measurements of living organisms, drug discovery, and manufacturing. In biomedical imaging, reflectance and fluorescence changes can be indicative of diseased tissue and help guide doctors during surgical procedures. In manufacturing, many materials are inherently fluorescent, and fluorescence components may be added as part of a product design. For example, certain paper and textiles include fluorescent dyes to improve appearance. Due to the separation between reflected and fluoresced photons, it may be difficult to distinguish between reflected and fluoresced photons through observations. It is easy to mistake fluoresced photons for reflected ones. Embodiments in accordance with the present disclosure are directed to jointly estimating reflectance and fluorescence spectras using a simple, inexpensive apparatus that estimates both properties, which can address challenges as noted above. For example, the reflectance and fluorescence spectra estimation can be formulated as an inverse estimation and unknown quantities can be estimated in a single optimization step. In accordance with specific embodiments, an apparatus and/or method is used to measure product quality by efficiently measuring both reflectance and the effect of fluorescent additives in manufactured products.

In some instances, devices estimate either reflectance or fluorescence properties. For example, one property, such as the reflectance, is estimated at a first step, a number of intermediate components are estimated in a second (or more) step, and then the other property, such as fluorescence, is estimated. Embodiments in accordance with the present disclosure simultaneously estimate reflectance, and both fluorescence absorption and emission spectra using a single optimization step. Various example embodiments obtain both types of spectral characterizations using far fewer measurements than other methods, and thereby reducing acquisition time. Also, specific embodiments of the present application concern measuring both reflectance and fluorescence properties for all points in an image and across a whole spectra.

In accordance with specific embodiments, an apparatus and/or methods are directed to jointly estimating reflectance and fluorescence properties of multiple fluorophores present in a target at the same time. For example, in accordance with the present disclosure, it has been discovered that there is chromaticity variants in certain situations, such as when multiple fluorophores are present. Certain embodiments in accordance with the present disclosure do not assume that there is chromaticity invariants and, thereby, estimate spectral properties of multiple fluorophores jointly. However, in other embodiments, chromaticity invariants is assumed.

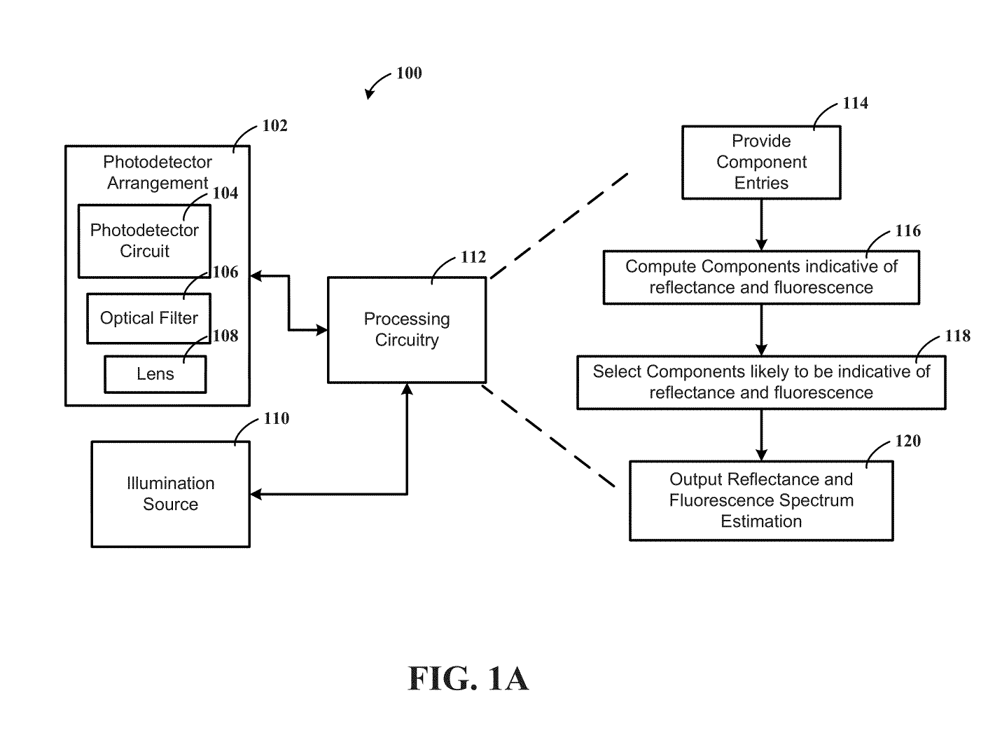

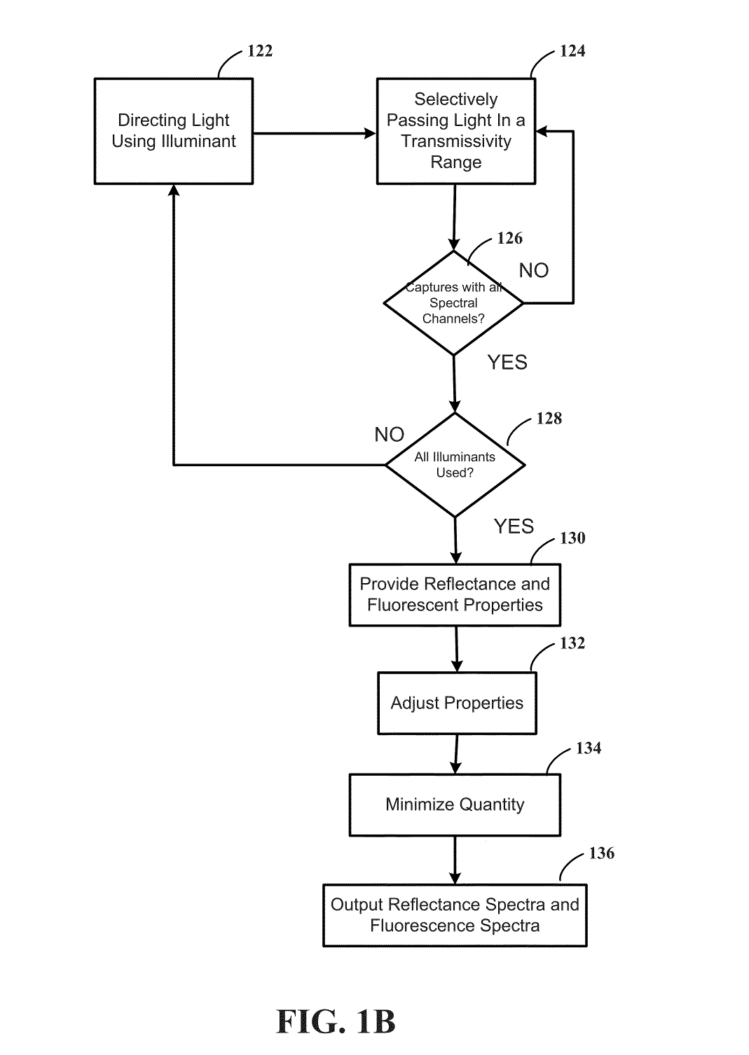

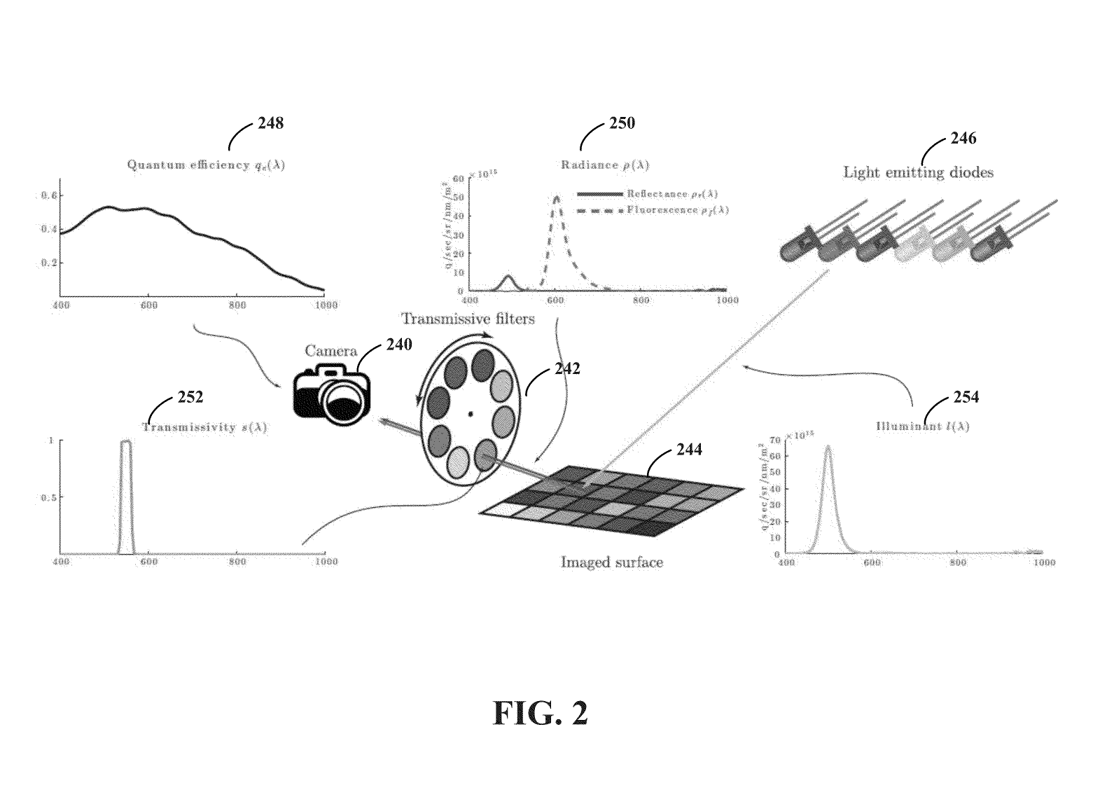

Various embodiments are directed to apparatuses (devices and/or systems), methods of use and/or method of manufacturing apparatuses, which include or more of the aspects described herein, and as may be implemented separately or together with the present disclosure, which includes the attached figures, claims and Appendix A of the underlying provisional application. Certain aspects of the instant disclosure are directed to an apparatus/method of use involving simultaneous material characterization in terms of reflectance and fluorescence properties, as may be implemented in biological and/or industrial applications. Such simultaneous material characterization may include performing one of the models disclosed and/or discussed in connection with FIG. 1A or FIG. 2, and in connection with aspects noted in the instant disclosure, such as spectral estimation aspects. Such apparatuses/methods may further include use of and/or integration with an imaging system. The formulae and models are implemented in the present disclosure. Estimation models, e.g., for simultaneous reflectance and fluorescence estimation, are provided with use of an imaging system. In certain embodiments, an arbitrary number of channels and/or LED light sources are permitted. Also in certain embodiments, such estimations may be provided by using a single optimization step.

Various other embodiments are directed to an apparatus, system, method of use, method of making, or material directed to one or more of the following aspects, as may be implemented separately or in connection with one or more others of the following aspects or other embodiments discussed and/or shown herein. Certain aspects of the instant disclosure are directed to simultaneously estimating material reflectance and fluorescence that is based on an estimation model applied to pixel intensities acquired using a customized, multispectral imaging system. The model is used to estimate reflectance and fluorescent material properties from sensor responses by using a specific fluorescent image formation model and corresponding signal estimation methods (a bi-linear optimization method).

To test the method as part of an experimental embodiment, a multispectral imaging system is used to acquire a series of images of the same materials illuminated by a plurality of different spectral lights, and captured by a plurality of sensors with different spectral responses. The system uses an illumination source made of a number of LEDs emitting light in the ultra violet (UV) through visible to near infrared (NIR) bands. Each LED has an emission spectrum that resembles a Gaussian curve. In addition to the illumination sources, the imaging system includes a monochromatic camera, a lens, and a filter wheel that selectively inserts a single optical bandpass filter into the optical path. Consequently only the wavelengths transmitted through the filter reach the photodetector and contribute to the sensor responses. The system acquires an image for each sensor filter and illumination band.

A related example embodiment implements a system with eight LEDs and nine imaging filters that capture 8×9=72 images. As an alternate-related model, the reflectance and fluorescence parameters are estimated by minimizing the residual error in the image formation model. The optimization problem is bi-linear with a small number of affine constraints. The optimal point is found by solving a sequence of convex optimization problems. Variations include the number of discrete illumination channels and the number of sensor bands. These parameters can be selected for high performance in spectra reconstruction, which may involve a large number of filters and lights. Alternatively, if for example types of imaged spectra are known in advance, fewer lights and filters may be selected to reduce acquisition time. The illumination can be produced using different methods, e.g., by replacing the LEDs with a wideband source and a small number of bandpass filters that are inserted mechanically into the light path, using a liquid crystal tunable filter (LCTF), or placing a monochromator in the light path. Similarly, the camera/imaging system acquires spectral data in a variety of ways: The rotating filter wheel may be replaced by an LCTF, or the monochromatic camera can be replaced with one containing a custom-made color filter array.

In accordance with various specific embodiments, captured intensity characteristics indicative of a target are used to jointly estimate a reflectance spectra and a fluorescence spectra of a target. The intensity characteristics are captured using a photodetector arrangement that acquires intensities and/or images of a target that is illuminated using different illuminants and passing the resulting light in different spectral bands. Based on the measured intensity, the respective spectra are estimated using an image formation model. The image formation model includes known variables associated with the photodetector arrangement, the illuminants, and the spectral bands, and the only unknown variables are the spectras. The spectras are estimated by iteratively solving the image formation model using various estimates of the reflectance and fluorescence spectra and comparing the predicted intensities to the measured intensities. The estimates are iteratively adjusted to reduce the error between the predicted intensities and the measured intensities, as well as other functions of the spectras (e.g., smoothness and nuclear norm of the fluorescence matrix as discussed further herein). The initial reflectance properties and fluorescent properties of each spectra are provided by a pseudo-random process (e.g., random values) and/or can be based on knowledge of the target. In various embodiments, the initial properties are concurrently adjusted to reduce a quantity indicative of a combination of: a difference between the captured intensity characteristics and intensities predicted using an image formation model incorporating the reflectance properties and fluorescence properties, functions of the reflectance properties, and functions of the fluorescence properties. The adjustment can include an iterative process until the quantity is minimized (e.g., converges). A reflectance spectra estimation and a fluorescent spectra estimation are output for the fluorophore, based on the adjusted reflectance properties and fluorescence properties. Furthermore, the target, in some specific embodiments, includes more than one fluorophore and the output includes reflectance spectra estimation and a fluorescent spectra estimation for each fluorophore present.

In accordance with related aspects, the images and/or intensity characteristics are captured using an imaging apparatus. The imaging apparatus includes an illumination source, a photodetector arrangement, and processing circuitry. The illumination source directs a plurality of different illuminants toward the target. In specific embodiments, the illumination source includes a plurality of LEDs. The photodetector arrangement, which includes a photodetector circuit, selectively passes light in each of a plurality of different spectral bands to a photodetector circuit. In a number of specific embodiments, the photodetector arrangement includes an optical filter configured to selectively pass the light. The photodetector circuitry captures the intensity characteristics indicative of target acquired in the plurality of different spectral bands and under the plurality of different illuminants. The processing circuitry processes the captured intensity characteristics, as described above.

The target, in various specific embodiments, includes biological tissue. A sample of the biological tissue is imaged using an imaging apparatus. The imaging apparatus includes an illumination source, a photodetector arrangement, and processing circuitry. The illumination source directs a plurality of different illuminants toward the sample. Light from the illuminant is reflected and refracted from the sample and is passed in each of a plurality of different spectral bands to a photodetector circuit of the photodetector arrangement. In various embodiments, an optical filter is used to selectively pass the light in the different spectral bands. The photodetector arrangement captures a set of images of the sample acquired in the plurality of different spectral bands and under the different illuminants. The intensities captured are used to iteratively determine reflectance and fluorescence of a number of fluorophores present in the sample. Further, the sample can be imaged over time and the reflectance and fluorescence changes can be indicative of diseased tissue and/or help guide doctors during surgical procedures. In other specific embodiments, the target can include a man-made object (e.g., paper, textiles, and displays), and/or other natural material. For example, the estimated reflectance and fluorescence spectra can be used to measure product quality by efficiently measuring both reflectance and the effect of fluorescent additives in manufactured products.

Turning now to the figures, FIG. 1A shows an apparatus 100, in accordance with an example embodiment of the present disclosure. The apparatus includes an illumination source 110, photodetector arrangement 102, and processing circuitry 112.

The illumination source 110 illuminates a target by directing (e.g., providing) a plurality of different illuminants (e.g., spectral lights) towards the target. The different illuminants span a spectrum and includes different wavelength ranges. The target can include items such as a biological sample, a tissue-sample, a man-made object (e.g., such as paper), a chemical sample, and a natural object. The illumination source 110, in some embodiments, includes a plurality of lights, such as a plurality of LEDs. In other embodiments, the illumination source 110 includes a wideband illumination source. The photodetector arrangement 102 includes photodetector circuitry 104. The photodetector arrangement 102 selectively passes light in each of a plurality of different spectral bands to the photodetector circuit 104. The selectively passed light, in various embodiments, includes a plurality of different transmissivity ranges (e.g., wavelengths are transmitted). The photodetector circuit 104 is configured to capture intensity characteristics of the selectively passed light acquired in the plurality of different spectral bands and under each of the plurality of different illuminants.

In various embodiments, the photodetector arrangement 102 includes an optical filter 106 and a lens 108. The optical filter 106 is arranged in an optical path between the photodetector circuit 104 and the target, and configured to pass light of each of the plurality of different illuminants and in different spectral bands. For example, using the optical filter 106, a particular wavelength is transmitted through the optical filter, reaches the photodetector circuit 104 and contributes to sensor response of the photodetector circuit 104. Thereby, each filter includes a specific spectral band transmissivity. In a number of embodiments, the target is illuminated with a single narrowband spectral light from a small collection of available spectral lights, using the illumination source 110 and the optical filter 106, and images of this target are captured by the photodetector circuit 104 through a few narrowband filters.

The optical filter 106, in accordance with various embodiments, includes a wheel and/other rotatable shape that includes a plurality of filters. For example, in some embodiments, the optical filter includes 5-20 filters that are each located on a rotatable shape and that pass light in a different transmissivity range. In various embodiments, the optical filter 106 includes a plurality of filters, a monochromator, a color-filter array comprised of a plurality of filters, a liquid crystal tunable filter, or a combination thereof. The illumination source 110, in various embodiments, includes a plurality of LED lights, each of which illuminates the target in a different spectral light. In some embodiments, each LED emits light in the UV through visible to NIR bands. In other embodiments, the illumination source 110 includes a wideband illumination source configured and arranged to emit light in the plurality of different wavelengths spanning a spectrum.

In some embodiments, the photodetector arrangement 102 includes a lens 108 and is configured and arranged to assess intensity characteristics of the passed light in each of the different spectral bands after the light passes through an optical filter 106. In various embodiments the photodetector circuit 104 captures a set of images (e.g., a series of images) of the target, with the images being acquired using the selectively passed light in each of the different spectral bands and under the different illuminants. The captured intensity characteristics, in some embodiments, include pixel intensity of the set of images. The photodetector arrangement 102 can include a monochromatic camera. For example, the photodetector arrangement 102 may acquire a set of images of the target (e.g., the same material) as illuminated by different illuminants and captured by a plurality of spectral channels. Spectral channels, as used herein, are defined by a filter and a spectral response of a sensor of the photodetector arrangement 102 (e.g., the photodetector circuit 104 includes a number of sensors with different spectral responses).

In a number of specific embodiments, the illumination source 110 illuminates the target by providing and/or directing the different illuminants sequentially, each illuminant being in one of a different spectral band/wavelength range. Further, the photodetector arrangement 102 selectively passes light to the photodetector circuit 104 by sequentially providing each of a plurality of filters of the optical filter 106 in the optical path between the photodetector circuit 104 and the target, and thereby, selectively passing the light for each of the different spectral bands (e.g., in a plurality of different transmissivity ranges) and under the plurality of different illuminants.

The processing circuitry 112 is configured and arranged to process the captured light characteristics. For example, the processing circuitry 112, in a number of embodiments, jointly estimates a reflectance spectra and a fluorescence spectra of the target. The estimation may, in some embodiments, be made for each pixel of a plurality of images acquired. In various embodiments, the intensity characteristics are captured and reflectance properties and fluorescent properties of the target are provided. The provided properties can be pseudo-random, in various embodiments. In other embodiments, the provided properties can be based on known information (e.g., known qualities of the material/target). The reflectance and fluorescent properties are concurrently adjusted to reduce a quantity indicative of a combination of a difference between the captured intensity characteristics and predicted intensities. Such intensities may be predicted using an image formation model incorporating the reflectance properties and fluorescence properties (e.g., the component entries), functions of the reflectance properties, and functions of the fluorescence properties. A reflectance spectra estimation and fluorescence spectra estimation for a fluorophore in the target, in various embodiments, is output based on the adjusted reflectance and fluorescence properties.

In a number of embodiments, the adjustment is based on minimizing a sum of a difference (e.g., an error) between the assessed pixel intensities of captured light and unknown reflectance and fluorescence spectra values in a fluorescence matrix, nuclear norm of the fluorescence matrix, and smoothness functions of the reflectance properties and the fluorescent properties. For example, the concurrent adjustment can include iteratively adjusting the reflectance properties and fluorescence properties to minimize a weighted sum of a difference (e.g., an error) between the captured intensity characteristics and intensities predicted using the image formation model incorporating the reflectance properties and fluorescence properties, the functions of the reflectance properties, and the functions of the fluorescence properties.

The functions of the reflectance properties and the functions of the fluorescence properties, in various embodiments, include smoothness functions relative to adjacent reflectance or fluorescence properties. For example, the smoothness function of the reflectance properties can include a smoothness of reflectance properties in a vector relative to adjacent spectral bands and/or pixels. The smoothness function of fluorescence properties can include a smoothness of fluorescent properties in a matrix relative to adjacent spectral bands and/or pixels. Smoothness, as used herein, includes less than a threshold change in reflectance or fluorescence values (e.g., basis) between spectral bands and/or pixels. In a number of embodiments, the threshold change can include ten basis or less for reflectance and twenty basis or less for fluorescence. If the change in the reflectance or fluorescence values is greater than the threshold, a weight (e.g., penalty) is added to the properties (and/or the associated vector or matrix).

In various embodiments, a nuclear norm of the fluorescence matrix is penalized (e.g., greater number of fluorophores results in penalty). For example, it can be assumed that the number of fluorophores present is small. A small number of fluorophores, as used herein, is less than twenty fluorophores. In some embodiments, with unknown reflectance and fluorescence spectrums, if two equivalent (e.g., equally weighted) solutions are determined, if one solution has fewer fluorophores than the other solution, the processing circuitry 112 uses the solution with fewer fluorophores to estimate the reflectance and fluorescence spectrums.

The estimation, as explained in further detail herein, in some embodiments, includes iteratively minimizing an error between model predictors of an image formation model (e.g., the fluorescence and reflective spectrums) and the intensity characteristics using a single optimization step, and estimating the reflectance and fluorescence of the target object based on the minimized error. As discussed in more detail below, the processing circuitry 112, for each of the different spectral bands, provides component entries corresponding to fluorescence and reflectance contributions in each of the different light bands, computes components indicative of the reflectance and fluorescent spectra, selects which of the components are likely to be indicative of the reflectance spectra and the fluorescence spectra and outputs the respective spectra estimations.

As illustrated by FIG. 1A, the processing circuitry 112 processes the passed light, at block 114, by using the captured intensity characteristics to provide component entries that correspond to and characterize fluorescence and reflectance contributions for each of the different spectral bands. The component entries, as used herein, include basis values for fluorescence (e.g., emissivity and absorption) and reflectance under a respective illuminant and in a plurality of spectral band (the filters). For example, providing the component entries for each of the different spectral bands can include providing values using a pseudo-random technique. The different component entries can be provided for each of selectively passed light in the different spectral bands (e.g., spectral channels) and the plurality of illuminants.

At block 116, in response to the provided component entries, the processing circuitry 112 concurrently computes components indicative of reflectance spectra estimation and fluorescence spectra estimation based on the captured intensity characteristics of the selectively passed light and based on the computed components having a smoothness function relative to adjacent ones of the different spectral bands and/or spectral channels. The computed components include adjustments to the component entries that correspond to and characterize fluorescence and reflectance contributions for the entire spectrum (e.g., the plurality of different wavelengths spanning a spectrum) and across the plurality of transmissivity ranges. For example, adjusted pseudo-randomly provided component entries can be computed to reduce a quantity indicative of a combination of a difference between the captured intensity characteristics and intensities predicted using an image formation model incorporating the reflectance properties and fluorescence properties and the smoothness functions.

The quantity is indicative of, in various embodiments, a combination of factors, and such factors can be weighted. In some embodiments, the quantity is indicative of a combination of the difference between the captured intensity characteristics and intensities predicted by an image formation model incorporating the computed components, and the smoothness functions of the computed components. In other embodiments, such as when the number of fluorophores present is unknown and/or known to be greater than one, the quantity is indicative of the difference between the captured intensity characteristics and intensities predicted by an image formation model incorporating the computed components, the smoothness functions of the computed components, and the nuclear norm of a fluorescence matrix. The fluorescence matrix, as discussed further herein, includes computed components that correspond to and characterize fluorescence contributions (e.g., the fluorescence properties).

As discussed in further detailed herein, the captured intensity characteristics, in various embodiments, are provided in a matrix and/or a vector. For example, in some embodiments, the captured intensity characteristics are provided in a matrix where the (i, j) entry represents the intensity characteristics captured with the ith spectral channel of the photodetector arrangement under the jth illuminant. The reflectance properties (including the pseudo-random, the adjusted, and/or iteratively adjusted values) are provided in a vector, where the ith vector entry represents the amount of light reflected in the ith spectral band. The fluorescence properties (including the pseudo-random, the adjusted, and/or iteratively adjusted values) are provided in a matrix, such as a square matrix, where the (i,j) entry represents the amount of light emitted by the fluorophore in the ith spectral band when illuminated with a light wavelength from the jth illuminant. The smoothness function of the reflectance properties, for example, is a function of the vector and is determined as a p-norm of the difference between adjacent vector entries. The smoothness function of the fluorescence properties is a function of the matrix and is determined between all columns and/or rows of the matrix. Although the present embodiments illustrates the captured intensity characteristics, reflectance properties, and fluorescence property provided in particular matrices and/or vectors, embodiments are not so limited and the various characteristics and properties can be provided in a variety of ways. For example, the various matrices can be formed in a variety of different ways, such as transposing the above described matrices so that the values described as in columns are in rows and vice versa. Further, the characteristics and/or properties can be represented as vectors.

At block 118, the processing circuitry 112 selects, among the concurrently computed components in each of the different spectral bands, ones of the computed components that are likely to be indicative of reflectance spectra estimation and fluorescence spectra estimation for a fluorophore in the target. The selection, as illustrated in further detail herein, includes and/or is based on a minimized weight of the computed components selected. In accordance with a number of embodiments, a weight for each of the computed components is provided. For instance, the computed components may have a first weight that is based on an error between the captured intensity characteristics and intensities predicted by an image formation model incorporating the computed components, and a second weight that is based on a smoothness function relative to adjacent ones of the different spectral bands.

As discussed further herein, the image formation model can include known values except for the reflectance and fluorescence properties. The known values include spectral properties of the photodetector arrangement and spectral power distributions of light (e.g., based on the illuminants and the spectral bands of the filters). In accordance with various embodiments, the spectral properties of the photodetector arrangement 102 are provided in a matrix, where the (i,j) entry represents sensitivity of the ith spectral channel of the photodetector arrangement to passed light in the jth spectral band. Further, the spectral power distributions of light are provided in a matrix, where the (i,j) entry represents the amount of light emitted by the jth illuminant in the ith spectral band. The matrix of the spectral properties of the photodetector arrangement and the matrix of the spectral power distributions of light are input into the image formation model and used, with the current iteration and/or predicted fluorescent and reflectance properties, to predict an intensity. The predicted intensity is compared to the actual intensity measured and the error is used as a weighted value. The known values are provided, in various embodiments, before, during, and/or after capturing the intensity characteristics. Furthermore, the known values are provided, in some embodiments, by processing circuitry of the photodetector apparatus, external processing circuitry, and/or via user input, among other sources. Although the present embodiments illustrates representing the known properties in particular matrices, embodiments are not so limited and the various properties can be provided in a variety of ways. For example, the various matrices can be formed in a variety of different ways, such as transposing the above described matrices so that the values described as in columns are in rows and vice versa. Further, the known properties can be represented as vectors.

In some embodiments, an additional weight for the computed components is determined and/or used. For example, the quantity that is reduced that is indicative of combination (e.g., the weighted sum) can include minimizing a weight of a nuclear norm of a fluorescence matrix comprised of the fluorescence properties. For example, in various embodiments, the fluorescent properties are generated by more than one fluorophore that is present in the target. The image formation model can be used to estimate the number of fluorophores present. In response to the number of fluorophores computed as being present in the target being greater than a threshold number of fluorophores, a weight can be added. For example, the target can include a plurality of fluorophores. In other embodiments, additional weight can be added. For example, an additional constraint can be added on the values of the reflectance and the fluorescence properties, such as the values are non-negative, as discussed further herein.

At block 120, the processing circuit 112 outputs said reflectance spectra estimation and fluorescence spectra estimation for the fluorophore in the target using the selected components. For instance, when the target has a plurality of different fluorophores, the processing circuitry 112 may jointly provide component entries, concurrently compute components indicative of reflectance spectra estimation and fluorescence spectra estimation, select concurrently computed components, and output a reflectance spectra estimation and fluorescence spectra estimation for each of the plurality of different fluorophores in the target. In other embodiments, the target has only one fluorophore. In either embodiments, the output reflectance spectra estimation describes a fraction of incident reflected photons that are reflected at each wavelength of the spectrum and the output fluorescence spectra estimation describes light absorbed by the target in a first sub-set of wavelengths of the spectrum and emitted photons that are re-emitted at a second subset of the wavelengths of the spectrum.

FIG. 1B shows an example process of jointly estimating reflectance and fluorescence spectrums in accordance with various embodiments. At block 122, light is directed toward a target using an illuminant such as light in a particular wavelength range of a spectrum. In various embodiments, an illumination source can include a plurality of different illuminants, each illuminant providing directed light in particular wavelength ranges that span the spectrum. At block 124, light in a spectral band (e.g., transmissivity range) is selectively passed via a photodetector apparatus. As previous discussed, intensity characteristics of the target may be captured by illuminating the target with an illuminant and passing light in the spectral band. At block 126, a determination is made as to whether intensity characteristics are captured in all spectral channels for the illuminant. In response to determining that intensity characteristics have not been captured in all spectral channels for the illuminant, the process returns to block 124 and the light is passed in a different spectral band (e.g., transmissivity range) of the optical filter to the photodetector circuit. Responsive to capturing intensity characteristics in all spectral channels for the illuminant, a determination is made as to whether all illuminants of the illumination source have been used to illuminant the target, at block 128. In response to determining that not all illuminants have been used, the process returns to block 122 and provides directed light using a different illuminant and selectively passes the light in the spectral bands (at block 124).

In response to determining that light has been directed toward the target using each of the illuminants and, for each of the different spectral bands, light has passed to the photodetector circuit, at block 130, fluorescent and reflectance properties are provided (e.g., component entries correspond to and characterize fluorescence and reflectance contributions in each of the different spectral bands and illuminants). At block 132, the reflectance and fluorescence properties are concurrently adjusted to reduce a quantity indicative of a difference between the captured intensity characteristics and intensities predicted using an image formation model incorporating the reflectance properties and fluorescence properties, functions of the reflectance properties, and functions of the fluorescence properties. The functions of the reflectance and fluorescence functions include smoothness function relative to adjacent reflectance and fluorescence properties of the different spectral bands (and/or pixels).

At block 134, in various embodiments, the quantity is minimized, such as by using an iterative process. For example, the quantity can be minimized by iteratively adjusting the reflectance properties and fluorescence properties to minimize a weighted sum of a difference (e.g., an error) between the captured intensity characteristics and intensities predicted using the image formation model incorporating the reflectance properties and fluorescence properties, the functions of the reflectance properties, and the functions of the fluorescence properties. At block 136, reflectance spectra estimation and fluorescence spectra estimation for the fluorophore in the target are output based on the adjusted reflectance properties and fluorescence properties (e.g., based on the iterative adjustment and minimized quantity). The output, in various embodiments, includes a reflectance spectra estimation and fluorescence spectra estimation for each of a plurality of fluorophores in the target.

Although various embodiments illustrate providing component entries, computing of components, and adjustment of the components as occurring in response to all illuminants and spectral bands being passed, certain embodiments are not so limited. For example, component entries, components, and/or iterative minimization of a sum for a particular illuminant can be performed during the capturing of the intensity characteristics for a different illuminant. Further, component entries can be provided and/or adjusted for portions of the fluorescent matrix and/or reflectance vector during the capture of intensity characteristics for the selectively passed light. In various embodiments, the reduction of the quantity and/or minimization of the sum can be performed from reflectance properties followed by fluorescence properties, or vice versa. For example, the quantity is reduced that is indicative of a difference between the captured intensity characteristics and intensities predicted using the image formation model indicative of the reflectance properties and the smoothness function of the reflectance properties, followed by reduction of the quantity indicative of a difference between the captured intensity characteristics and intensities predicted using the image formation model indicative of the fluorescence properties and the smoothness function of the fluorescence properties. Alternatively, in some embodiments, the quantity is reduced that is indicative of a difference between the captured intensity characteristics and intensities predicted using the image formation model indicative of the fluorescence properties and the smoothness function of the fluorescence properties. This is followed by reducing the quantity that is indicative of a difference between the captured intensity characteristics and intensities predicted using the image formation model indicative of the reflectance properties and the smoothness function of the reflectance properties.

FIG. 2 shows an example apparatus in accordance with various embodiments shown by way of example as imaging a target, in accordance with an example embodiment of the present disclosure. The apparatus includes an illumination source 246, photodetector arrangement, and processing circuitry. As illustrated, the apparatus is composed of a camera 240 and a number of (narrowband) illumination sources 246, e.g., the LEDs, and optical filters 242, e.g., the transmissivity filter wheel. The subplots 248, 250, 252, 254 illustrated by FIG. 2 illustrate the different spectral quantities of the components of the apparatus. For example, the quantum efficiency of the camera 248, the filter transmissivity (e.g., transmissivity wavelength range) 252 and the illuminant (e.g., wavelength range) 254 are fixed and are optionally calibrated for. The total scene radiance (e.g., reflectance and fluorescence spectra) 250 is the unknown parameter that is estimated using the processing circuitry. The x-axis in the subplots 248, 250, 252, 254 represent wavelength and is scaled in nanometers.

For example, the photodetector arrangement's (e.g., camera 240) pixel intensity m is linearly related to the image radiance, wherein:

m=g∫qₑ(λ)s(λ)ρ(λ)dλ (1)

Where qₑ is the photodetector arrangement's quantum efficiency and s is the optical filter transmissivity 252. The scalar g represents photodetector parameters such as the ISO gain, exposure duration, and the aperture setting. Given a particular photodetector arrangement, all the parameters, except for the scene radiance, are fixed and known or can be calibrated for.

The radiance, ρ, of any point in an image is a superposition of radiances due to reflected ρᵣ, and fluoresced light ρ_{f}. Let ρ(λ) denote the total radiance at some wavelength λ, then:

p(λ)=ρᵣ(λ)+ρ_{f}(λ) (2)

Assuming smooth and isotropic Lambertian surfaces, the reflected radiance at some wavelength λ is computed as a product between the illuminant l(λ) and the surface reflectance r(λ), for example:

ρᵣ(λ)=l(λ)r(λ) (3)

Fluorescent radiance is produced by a number of different fluorescent compounds present in the sample. Often their individual contributions e_{f,z}(λ) are considered to be additive, for example:

ρ_{f}(λ)=Σ_{z=1}ρ_{f,z}(λ), (4)

where z indexes over different fluorophores.

In a number of embodiments, the fluorescent radiance due to a single fluorophore of ρ_{f,z}(λ) is described by a two dimensional function e_{xm,z}(λ,λₓ). This function expresses the number of emitted photons at a particular wavelength λ as a fraction of incident monochromatic light of some other and different wavelength λₓ. If a broadband light source is used, fluorescence emissions arising from illumination at all spectral bands of the incident light can be considered, such as:

ρ_{f,z}(λ)=∫e_{xm,z}(λ,λₓ)l(λₓ)dλₓ (5)

A number of fluorophores exhibit physical properties that allow simplification of the emission model. For example, the wavelength of the emitted photons is longer than that of exciting photons. This implies that:

e_{xm,z}(λ,λₓ)=0 if λ≦λₓ

Further, per Kasha's rule, the shape of the fluorescence emission is constant and only its intensity varies with changes in the illumination wavelength. This assumption, also called chromaticity invariance, implies that e_{xm,z}(λ,λₓ) is a separable function and is represented as a product of two univariate functions e_{xm,z}(λ,λₓ)=e_{x,z}(λ)e_{m,z}(λₓ).

The function e_{m,z}(λ) is called the emission spectrum, which represents the spectral power distribution of the fluorescent light emitted by the surface. The second function e_{x,z}(λₓ) is the excitation spectrum, sometimes referred to as the absorption spectrum, which describes the efficiency with which incident photons of different wavelengths excite the fluorescence signal. Under these assumptions, the fluorescence radiance due to a single fluorophore z may be expressed as:

ρ_{f,z}(λ)=e_{m,z}(λ)∫e_{x,z}(λₓ)l(λₓ)dλₓ (6)

The multiplicative relationship between the excitation and emission spectra implies that each of these spectra are arbitrarily re-scaled and, as long as the reciprocal scaling is applied to the other quantity, the result remains unchanged. Both spectra, in various embodiments, are normalized so that their maximum intensities are equal to one, or that the area under the curve is equal to one, i.e. ∫e(λ)dλ=1. If this is the case an additional intensity scalar is introduced into Equation 6 to reflect these normalizations.

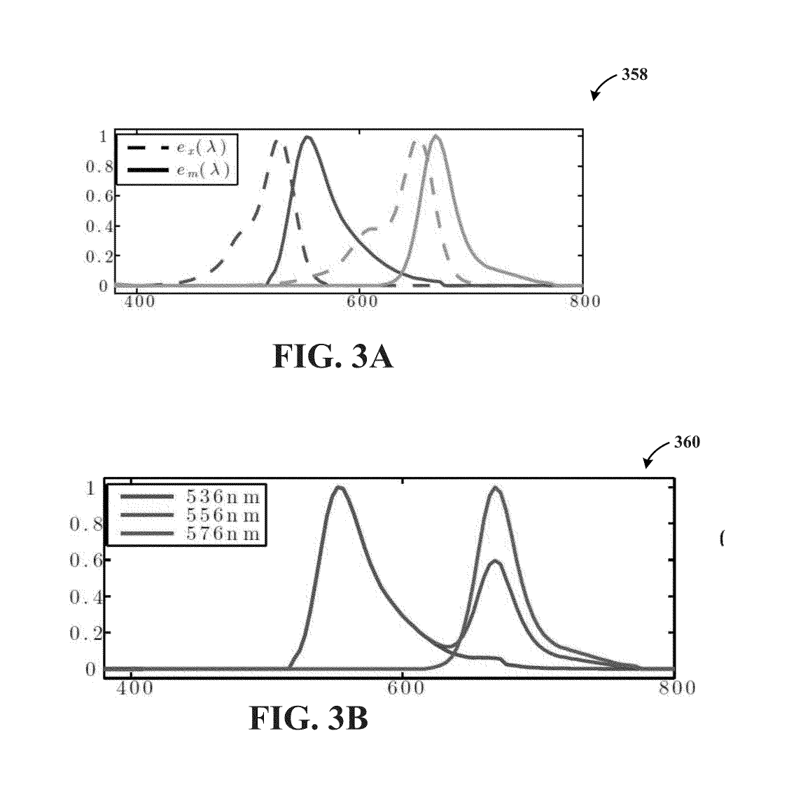

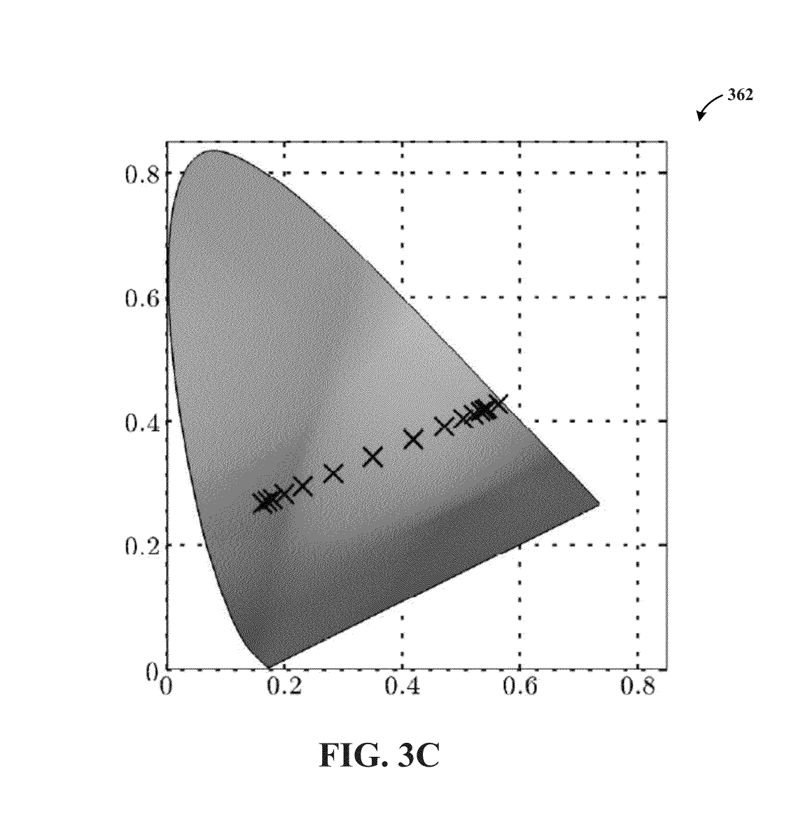

As previously discussed, embodiments in accordance with the present disclosure may not include the chromaticity invariance assumption. For example, Kasha's rule holds when the excitation and emission spectra do not overlap. When they do overlap, Stokes theorem implies that the emission spectrum will vary with the illumination. Furthermore, the emission spectrum is not invariant when two or more fluorophores are present in a sample; each of the fluorophores will contribute different amounts depending on the illumination. This effect is illustrated in FIGS. 3A-C, which show an example of a normalized emission spectra of a two fluorophore sample under different monochromatic lights in accordance with various embodiments.

FIG. 3A, for example, shows a graph 358 of the excitation (dashed) and emission (solid) of two fluorophores. FIG. 3B illustrates a graph 360 of the normalized spectral power distribution of light emitted under three monochromatic light sources. Further, FIG. 3C illustrates a graph 362 of the emission spectrum's chromaticity changes with the light source wavelength.

In various embodiments, a (discretized) image formation model is used. The spectral functions are represented using vectors and matrices quantized to d narrow spectral bins. When a particular surface with n fluorophores is observed using i different filters and under j different illuminants, the discrete image formation model may be written as:

M=G^{∘}C^{T}(diag(r)+T^{∘}Σ_{z=1}ⁿe_{m,z}e_{x,z}^{T})L, (7)

### Where:

$$T = [ \begin{matrix}0 & 0 & & & 0 \\ 1 & 0 & 0 & & \\ 1 & 1 & 0 & & \\ & & & ⋱ & \\ 1 & & & 1 & 0\end{matrix} ] \qquad ( 8 )$$

The diag(r) operator places the entries of the reflectance vector rεR^{d} along the diagonal of the matrix. The matrix Σ_{z=1}ⁿe_{m,z}e_{x,z}^{T} with components e_{m,z}, e_{x,z}εR^{d}, which is sometimes referred to as the fluorescence matrix (e.g., the Donaldson matrix), is a discrete representation of eₓₘ(λ,λₓ) function. The fluorescence matrix is element-wise multiplied (Hadamard product denoted with ^{∘}) with TεR^{dxd}, forcing this matrix into a lower triangular form. The columns of matrix C=diag(qₑ)[s₁, . . . sᵢ], CεR^{dxi} are formed by filter transmissivities scaled by the photodetector quantum efficiency, similarly L=[l₁, . . . lⱼ], LεR^{dxj} is a matrix whose columns are the illuminant spectral power distributions. The opth entry of G represents the photodetector gain parameter associated with the oth filter and pth illuminant. Finally, the opth entry of MεR^{ixj} is the pixel value observed through the oth filter and under the pth illuminant.

Reflectance and fluorescence spectra, in various embodiments, are smooth functions that fall within a low-dimensional subspace spanned by a number of basis functions. As a consequence any reflectance or fluorescence spectrum can be compactly represented using low dimensional linear models:

r=Bᵣwᵣ, (9)

e_{x,z}=Bₓw_{x,z}, (10)

e_{m,z}=Bₘw_{m,z}, (11)

Where BᵣεR^{dxn}^{ᵣ}, BₓεR^{dxn}^{ₓ} and BₑεR^{dxn}^{ₑ} are matrices whose columns are basis functions for reflectance, excitation and emission spectra respectively. Similarly wᵣ,w_{x,z},w_{e,z} are the corresponding weight coefficient vectors. This modeling approach permits a reduction in the number of parameters in the image formation model.

The compact image formation model, with linear approximations for reflectance, excitation and emission spectra of Equations 9-11 expresses measured pixel intensities in terms of basis function weights, such as:

M=G∘C^{T}(diag(Bwᵣ)+T∘BₘWBₓ^{T})L, (12)

where:

W=Σ_{z=1}ⁿw_{m,z}w_{x,z} (13).

Note that rank(W)=n and WεRⁿₑ^{xn}ₓ.

In various embodiments, the processing circuitry uses the image formation model (e.g., Equation 12 and 13) and data to estimate the reflectance and fluorescence spectrums of the target. For example, the processing circuitry utilizes a variety of functions that estimate reflectance and fluorescence of a sample containing multiple fluorophores, a single fluorophore, and/or estimate the emission spectrum. The functions minimize a weighted sum of an error between the assessed intensity characteristics of captured light and unknown reflectance and fluorescence spectra, a nuclear norm of a fluorescence matrix, and penalty terms for smoothness in the fluorescence matrix and the reflectance. A solution that results in a minimized weight is used to estimate the reflectance and fluorescence, as described in further detail herein.

### MORE DETAILED/EXPERIMENTAL EMBODIMENTS

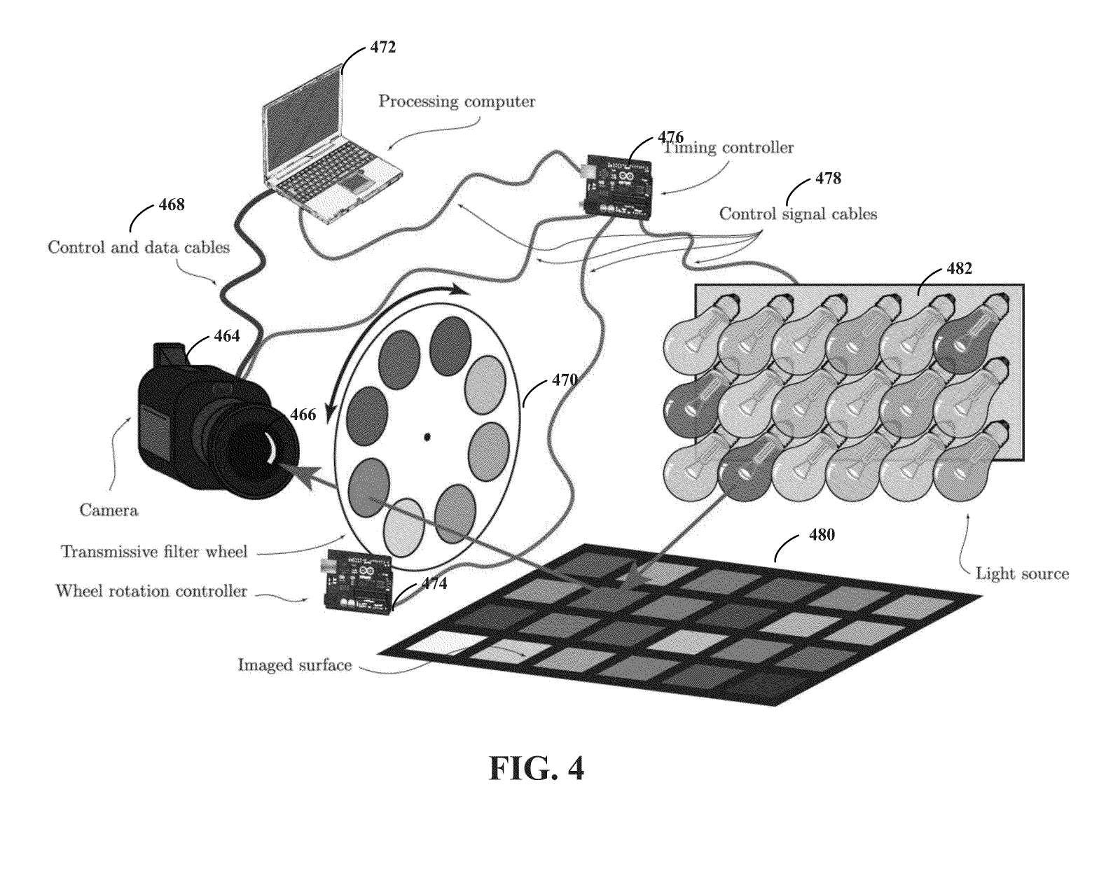

A variety of different photodetector arrangements can be used. FIG. 4 shows a specific example embodiment of an apparatus including a particular photodetector arrangement. As illustrated by FIG. 4, the apparatus includes a photodetector arrangement that includes a camera 464, a lens 466, and an optical filter 470. The optical filter 470, in some embodiments, includes a filter wheel with a plurality of filters that is rotated and/or otherwise moved using a wheel rotation controller circuit 474 and a timing controller circuit 476 that are both in communication with the processing circuitry 472 (e.g., processing computer). As further illustrated, the processing circuitry 474 is in communication with the camera 464, the timing controller circuit 476, and the wheel rotation controller circuitry 474 via control and data cables 468, 478. Alternatively, in some embodiments, the communication includes a wireless communication.

The illumination source 482, in accordance with various embodiments, includes a discrete number of LEDS configured and arranged to direct light toward the target 480. The directed light includes different light wavelengths spanning a spectrum associated with the target 480. For example, the illumination source 482 selectively provides directed light in the different wavelength ranges toward the target 480. The number of wavelengths and/or ranges are pre-selected and/or otherwise calibrated in various embodiments. Further, the timing control circuit 476 directs the illumination source 482 to provide the particular wavelength range at a particular time, which is controlled using the processing circuitry 472, in some embodiments.

In various embodiments, the optical filter 470 selectively passes light for each of the different spectral bands, as provided by the illumination source 482, in a plurality of different transmissivity ranges. The timing control circuit 476 and the wheel rotation controller circuitry 474, in various embodiments, direct the optical filter 470 to provide a particular transmissivity range by providing a particular filter in the optical path between the photodetector circuit and the target 480. The processing circuitry 472 controls the timing, in various embodiments, by sending control signals to the timing control circuit 476. Furthermore, the combination of the selective spectral band (e.g., filter) and the response of the sensor results in particular sensor channels.

Responsive to the controlled filter and illuminant, in various embodiments, the photodetector circuitry captures a series of images of the target 480 using the selectively pass light (via each of the filters) in each of the different light bans (via the LEDS). The photodetector circuitry assess the selectively passed light and captures intensity characteristics. The intensity characteristics, in some embodiments, includes pixel intensity of the series of images that are captured using the different sensor channels. That is, the optical filter 470 selectively inserts a single optical filter into the optical path for one of the respective images; thereby only the wavelength transmitted through the optical filter 470 reaches the photodetector circuit and contributes to the sensor response for the respective image.

The processing circuitry 472 processes the captured light and/or captured intensity characteristics. For example, the processing circuitry 472, for each different spectral band, using the captured intensity characteristics, provides component entries (e.g., entries for a vector indicative of reflectance spectra and a matrix indicative of fluorescence spectra) that correspond to and characterize fluorescence and reflectance contributions in each of the different spectral bands. And, in response to the provided component entries, the processing circuitry 472 concurrently computes components indicative of reflectance spectra estimation and fluorescence spectra estimation based on the captured intensity characteristics of the selectively passed light in the different spectral bands (and under the different illuminants) and based on the computed components having a smoothness function relative to adjacent ones of the different spectral bands.

The component entries are used to calculate a predicted intensity, using an image formation model, as previously discussed, and to reduce a quantity indicative of a combination of a difference between the captured intensity characteristics and intensities predicted and the functions of the reflectance properties and fluorescence properties. The component entries are provided for each of the spectral bands and across the different illuminants. The components indicative of the reflectance spectra estimation and fluorescence spectra estimation, in various embodiments, include iteratively adjusted component entries (e.g., components of reflectance vector and the fluorescence matrix) for the plurality of different spectral bands and across the different illuminants. Further, the components, in some embodiments, are based on the smoothness function relative to adjacent ones of the different spectral bands. For example, particular components (e.g., matrix/vector) include weighted values in response to the computed components resulting in non-smoothness between adjacent ones of the different spectral bands (e.g., greater than a threshold change in fluorescent basis and/or reflectance basis between adjacent spectral bands in the reflectance vector or the fluorescence matrix).

Using the image formation model and data, in various detailed embodiments, the reflectance and fluorescence spectra are estimated that minimize the Euclidean error between model predictions (intensity predicted) and measurements M. That is, in order to select particular ones of computed components that are likely to be indicative of the reflectance spectra and the fluorescence spectra, a weighted sum of an error between the captured intensity characters and intensities predicted using an image formation model indicative of the computed components, the smoothness function, and/or a weighted value of the nuclear norm of the fluorescence matrix is minimized. The components that result in the minimized weights are selected and output as an estimate of the reflectance spectra and the fluorescence spectra.

In accordance with various embodiments, a number of estimation functions are used. The following three estimation functions are provided for illustrative purposes and are not intended to limit the scope of the present disclosure. The first example function is a general method applicable when multiple fluorophores are present in a sample. A second example function is a simplified version of the first function for a case when the sample is known to contain a single fluorophore. A third example function is for a case when only the emission spectrum is estimated.

The first example function, for ease of reference, is herein referred to as the multi-fluorophore model. The multi-fluorophore model estimates reflectance basis function weights wᵣ and a matrix W that minimize the Euclidean error in the measurements M subject to physics motivated constraints by:

$$\begin{matrix}\begin{matrix}minimize & {\vert M - G ∘ {C}^{T} ( diag ( {Bw}_{r} ) + T ∘ {B}_{m} {WB}_{x}^{T} ) L \vert}_{F}^{2} + \\ & α {\vert ∇ {B}_{r} {w}_{r} \vert}_{2}^{2} + β {\vert ∇ ( T ∘ {B}_{m} {WB}_{x}^{T} ) \vert}_{F}^{2} + \\ & β {\vert ( T ∘ {B}_{m} {WB}_{x}^{T} ) {∇}^{T} \vert}_{F}^{2} \\ subjectto & 0 \leq {Bw}_{r} \leq 1 , \\ & 0 \leq T ∘ {B}_{m} {WB}_{x}^{T} , \\ & rank ( W ) = n ,\end{matrix} \\ and & ( 14 ) \\ ∇ = [ \begin{matrix}1 & - 1 & & 0 \\ 0 & 1 & - 1 & \\ & & ⋱ & \\ 0 & & 1 & - 1\end{matrix} ] , & ( 15 )\end{matrix}$$

where |·|_{F} is the Frobenius norm of a matrix and the V operator computes differences between adjacent entries in a vector.

The objective function is composed of three terms. The first is a data fidelity term that measures the difference between the model and data. Two additional terms, scaled by α and β, penalize the objective if neighboring entries in the estimates of the reflectance Bᵣwᵣ, or the fluorescence matrix, sometimes called the Donaldson matrix BₑWBₓ^{T}, vary a lot. These terms encourage smooth solutions. Note that in the case of the Donaldson matrix the smoothness penalty is imposed on both the rows and columns.

The solution space, in various embodiments, is further constricted by three constraints. The first constraint follows from the fact that reflectance is a passive process, which does not create new photons. The second constraint is a consequence of non-negativity of light. Note however that the non-negativity is applied to the entire Donaldson matrix estimate, not the contributing fluorophore excitation and emission spectra. The third constraint enforces a solution with a specific number of fluorophores. The last constraint is cumbersome for two reasons. In general, the number of fluorophores that are present in a given sample is unknown in advance. Additionally, the rank equality constraint renders the optimization problem non-convex and hard to solve globally.

In various embodiments, the non-convex constraint is replaced with a convex penalty. The rank of a matrix is equal to the number of its nonzero singular values. As such, a less stringent constraint is imposed by penalizing the sum of all the singular values, matrix nuclear norm, which is a convex function. This penalty is analogous to an l₁ penalty which can be used to enforce solution sparsity. The substitution of nuclear norm penalty for rank constraint produces the following convex relaxation of the original problem:

$$\begin{matrix}minimize & {\vert M - G ∘ {C}^{T} ( diag ( {Bw}_{r} ) + T ∘ {B}_{m} {WB}_{x}^{T} ) L \vert}_{F}^{2} + \\ & α {\vert ∇ {B}_{r} {w}_{r} \vert}_{2}^{2} + β {\vert ∇ ( T ∘ {B}_{m} {WB}_{x}^{T} ) \vert}_{F}^{2} + \\ & β \vert ( T ∘ {B}_{m} {WB}_{x}^{T} ) {∇}^{T} {\vert}_{F}^{2} + η {\vert W \vert}_{★} \\ subjectto & 0 \leq {Bw}_{r} \leq 1 , \\ & 0 \leq T ∘ {B}_{m} {WB}_{x} ,\end{matrix} \qquad ( 16 )$$

where |W|_{★} denotes the nuclear norm of W and η is the penalty tuning parameter. This convex optimization problem, which can be referred to as multi-fluorophore, is solved for using the Alternating Direction Method of Multipliers (ADMM) to enforce the matrix BₘWBₓ estimate to have rank n.

An ADMM, in a number of embodiments, is used in connection with the multi-fluorophore model. To use ADMM to solve an optimization function, the model is converted into a standard form, without inequality constraints. The inequality constraints are incorporated in the objective by using set indicator functions. An equivalent problem to Equation 16 containing equality constraints only is given as Equation 25, as illustrated below. The two functions I_{□} and I_{Δ} are set indicator functions representing constraints from the original problem. The first function, constraining the reflectance estimate to the [0,1] interval, is defined as

$${I}_{•} ( y ) = \{ \begin{matrix}0 & if 0 \leq {y}_{i} \leq 1 ∀ i \\ ∞ & otherwise\end{matrix} \qquad ( 17 )$$

The second function restricts the Donaldson matrix estimates to a set of matrices with nonnegative entries in their lower triangular part:

$${I}_{Δ} ( Y ) = \{ \begin{matrix}0 & if {y}_{ij} \geq 0 ∀ j \geq i \\ ∞ & otherwise\end{matrix} \qquad ( 18 )$$

ADMM is an iterative approach to solving optimization problems. At every iteration the augmented Lagrangian (Equation 26) is minimized first over wᵣ,W and then over y₁,Y₂, Y₃. Then the dual variables u₁,U₂,U₃ are updated before proceeding to the next iteration. The constant in the Lagrangian represents all the terms that are not functions of the optimization variables and do not influence minimization. Also note that the Lagrangian is separable in variables y₁, Y₂, Y₃ and therefore each of these optimization steps, in some embodiments, are performed independently. The variable update equations at iteration t are given in Equations 27-33, in some embodiments. The wᵣ,W update consists in solving an unconstrained least-squares problem, which can be performed using an iterative method; conjugate gradient function initialized with the solution estimated from the previous ADMM iteration (Equation 17). y₁ update is given by:

y₁^{t+1}P□(Bᵣwᵣ^{t+1}+u₁¹), (19)

where the P_{□}(x) projects every entry of x onto the interval [0,1]:

P□(xᵢ=min(max(xᵢ,0),1). (20)

In a similar fashion the Y₂ update is given by:

Y₃^{t+1}=PΔ(BₘW^{t+1}B_{z}^{T}+U₂¹), (21)

an operator that projects a matrix onto a set of nonnegative, lower-triangular matrices:

$${𝒫}_{Δ} ( {y}_{ij} ) = \{ \begin{matrix}{y}_{ij} & if {y}_{ij} \geq 0 ⋀ ∀ i > j \\ 0 & otherwise\end{matrix} . \qquad ( 22 )$$

The final update step is a nuclear norm proximal operator. Let W^{t+1}+U^{t}₃=USV^{T}, be the singular value decomposition of W^{t+1}+U^{t}₃, then the update operator is given by:

Y₃^{t+1}=US_{η/ρ}(S)V^{T}. (23)

The function S_{ν}(x) is the element-wise soft thresholding operator:

S_{ν}(xᵢ)=sign(xᵢ)(|xᵢ|−ν)₊. (24)

When the soft thresholding operator is replaced by one that selects n largest singular values the rank of the Donaldson matrix becomes n. This change corresponds to a non-convex equality constraint rank(W)=n and consequently the ADMM model may converge to a local minimum:

$$\begin{matrix}\begin{matrix}{minimize}_{{w}_{r} , W , {y}_{1} , {Y}_{2} , {Y}_{3}} & {‖ M - G ∘ {C}^{T} ( diag ( {Bw}_{r} ) + T ∘ {B}_{m} {WB}_{x}^{T} ) L ‖}_{F}^{2} + α {‖ ∇ {B}_{r} {w}_{r} ‖}_{2}^{2} + \\ & β ( {‖ ∇ ( T ∘ {B}_{m} {WB}_{x}^{T} ) ‖}_{F}^{2} + {‖ ( T ∘ {B}_{m} {WB}_{x}^{T} ) {∇}^{T} ‖}_{F}^{2} ) + \\ & {I}_{•} ( {y}_{1} ) + {I}_{Δ} ( {Y}_{2} ) + η {‖ {Y}_{3} ‖}_{★} \\ subject to & {B}_{r} {w}_{r} - {y}_{1} = 0 \\ & {B}_{m} {WB}_{x}^{T} - {Y}_{2} = 0 \\ & W - {Y}_{3} = 0\end{matrix} & ( 25 ) \\ ℒ ( {w}_{r} , W , {y}_{1} , {Y}_{2} , {Y}_{3} ) = {‖ M - G ∘ {C}^{T} ( diag ( {Bw}_{r} ) + T ∘ {B}_{m} {WB}_{x}^{T} ) L ‖}_{F}^{2} + α {‖ ∇ {B}_{r} {w}_{r} ‖}_{2}^{2} + β ( {‖ ∇ ( T ∘ {B}_{m} {WB}_{x}^{T} ) ‖}_{F}^{2} + {‖ ( T ∘ {B}_{m} {WB}_{x}^{T} ) {∇}^{T} ‖}_{F}^{2} ) + {I}_{•} ( {y}_{1} ) + {I}_{Δ} ( {Y}_{2} ) + η {‖ {Y}_{3} ‖}_{★} + \frac{ρ}{2} ( {‖ {B}_{r} {w}_{r} - {y}_{1} + {u}_{1} ‖}_{2}^{2} + {‖ {B}_{m} {WB}_{x}^{T} - {Y}_{2} + {U}_{2} ‖}_{F}^{2} + {‖ W - {Y}_{3} + {U}_{3} ‖}_{F}^{2} ) + const & ( 26 ) \\ {w}_{r}^{t + 1} , {W}^{t + 1} = arg min {‖ M - G ∘ {C}^{T} ( diag ( {Bw}_{r} ) + T ∘ {B}_{m} {WB}_{x}^{T} ) L ‖}_{F}^{2} + α {‖ ∇ {B}_{r} {w}_{r} ‖}_{2}^{2} + β ( {‖ ∇ ( T ∘ {B}_{m} {WB}_{x}^{T} ) ‖}_{F}^{2} + {‖ ( T ∘ {B}_{m} {WB}_{x}^{T} ) {∇}^{T} ‖}_{F}^{2} ) + \frac{ρ}{2} ( {‖ {B}_{r} {w}_{r} - {y}_{1}^{t} + {u}_{1}^{t} ‖}_{2}^{2} + {‖ {B}_{m} {WB}_{x}^{T} - {Y}_{2}^{t} + {U}_{2}^{t} ‖}_{F}^{2} + {‖ W - {Y}_{3}^{t} + {U}_{3}^{t} ‖}_{F}^{2} ) & ( 27 ) \\ {y}_{1}^{t + 1} = arg min {I}_{•} ( {y}_{1} ) + \frac{ρ}{2} {‖ {B}_{r} {w}_{r}^{t + 1} - {y}_{1}^{t} + {u}_{1}^{t} ‖}_{2}^{2} & ( 28 ) \\ {Y}_{2}^{t + 1} = arg min {I}_{Δ} ( {Y}_{2} ) + \frac{ρ}{2} {‖ {B}_{m} {W}^{t + 1} {B}_{x}^{T} - {Y}_{2}^{t} + {U}_{2}^{t} ‖}_{F}^{2} & ( 29 ) \\ {Y}_{3}^{t + 1} = arg min η {‖ {Y}_{3} ‖}_{★} + \frac{ρ}{2} {‖ {W}^{t + 1} - {Y}_{3} + {U}_{3}^{t} ‖}_{F}^{2} & ( 30 ) \\ {u}_{1}^{t + 1} = {u}_{1}^{t} + {B}_{r} {w}_{r}^{t + 1} - {y}_{1}^{t + 1} & ( 31 ) \\ {U}_{2}^{t + 1} = {U}_{2}^{t} + {B}_{m} {W}^{t + 1} {B}_{x}^{T} - {Y}_{2}^{t + 1} & ( 32 ) \\ {U}_{3}^{t + 1} = {U}_{3}^{t} + {W}^{t + 1} - {Y}_{3}^{t + 1} & ( 33 )\end{matrix}$$

The Equations 26 and 18 can be used for jointly estimating reflectance and fluorescence spectrums. This estimation model solves the optimization problem:

$$\begin{matrix}{minimize}_{F , R , N} & {‖ F ‖}_{*} + α {‖ R ‖}_{1} \\ subject to & M = G ∘ {C}^{T} ( R + F ) L + N - \\ & 3 σ \leq N \leq 3 σ ,\end{matrix} \qquad ( 34 )$$

where R is a matrix representing reflectance properties, and F is the Donaldson matrix summarizing the contributions of fluorescence. Estimated quantities, represented by the three matrices F,R,N are related to the unknowns derived in the model as R=diag(Bᵣwᵣ) and F=BₘWBₓ^{T}. The N matrix is a slack variable that limits the amount of misfit between the model and the data. Note that in the above formulation R is not restricted to being a diagonal matrix, hence the model allows nonzero off-diagonal entries. Similarly F is not limited to lower triangular matrices.

To use ADMM, all inequality constraints are incorporated directly in the objective. This leads to:

minimize ∥Y₁∥_{★}+α∥Y₂∥₁+I_{σ}(Y₃)

subject to F−Y₁=0

R−Y₂=0

N−Y₃=0

G∘C^{T}(R+F)L+N=M, (35)

where I_{σ}(Y) is an indicator function defined as:

$${I}_{•} ( Y ) = \{ \begin{matrix}0 & if - 3 * σ \leq {y}_{ij} \leq 3 σ ∀ i , j \\ ∞ & otherwise\end{matrix} . \qquad ( 36 )$$

The augmented Largrangian of this problem as a function of primal variables F,R,N and scaled dual variables Y₁,Y₂,Y₃ is given by Equation 38. Alternating minimization over primal variables and scaled dual variables leads to the update rules illustrated by Equations 39-46. The primal variable update solves an unconstrained least-squares problem. The Y₁ variable update is identical to Equation 30. The Y₂ update is equivalent to applying element-wise soft thresholding to the matrix R^{t+1}+U^{t}₂,

$$\begin{matrix} {Y}_{2}^{t + 1} = {𝒮}_{α / ρ} ( {R}^{t + 1} + {U}_{2}^{t} ) . & ( 37 ) \\ ℒ ( F , R , N , {Y}_{1} , {Y}_{2} , {Y}_{3} ) = {‖ {Y}_{1} ‖}_{★} + α {‖ {Y}_{2} ‖}_{1} + {I}_{σ} ( {Y}_{3} ) + \frac{ρ}{2} ( {‖ F - {Y}_{1} + {U}_{1} ‖}_{F}^{2} + {‖ R - {Y}_{2} + {U}_{2} ‖}_{F}^{2} + {‖ N - {Y}_{3} + {U}_{3} ‖}_{F}^{2} + {‖ G ∘ {C}^{T} ( R + F ) L + N - M + {U}_{4} ‖}_{F}^{2} ) + const ( 18 ) & ( 38 ) \\ {F}^{t + 1} , {R}^{t + 1} , {N}^{t + 1} = arg min {‖ F - {Y}_{1}^{t} + {U}_{1}^{t} ‖}_{F}^{2} + {‖ R - {Y}_{2}^{t} + {U}_{2}^{t} ‖}_{F}^{2} + {‖ N - {Y}_{3}^{t} + {U}_{3}^{t} ‖}_{F}^{2} + {‖ G ∘ {C}^{T} ( R + F ) L + N - M + {U}_{4}^{t} ‖}_{F}^{2} & ( 39 ) \\ {Y}_{1}^{t + 1} = arg min {‖ {Y}_{1} ‖}_{★} + \frac{ρ}{2} {‖ {F}^{t + 1} - {Y}_{1} + {U}_{1}^{t} ‖}_{F}^{2} & ( 40 ) \\ {Y}_{2}^{t + 1} = arg min α {‖ {Y}_{2} ‖}_{1} + \frac{ρ}{2} {‖ {R}^{t + 1} - {Y}_{2} + {U}_{2}^{t} ‖}_{F}^{2} & ( 41 ) \\ {Y}_{3}^{t + 1} = arg min {I}_{σ} ( {Y}_{3} ) + \frac{ρ}{2} {‖ {N}^{t + 1} - {Y}_{3} + {U}_{3}^{t} ‖}_{F}^{2} & ( 42 ) \\ {U}_{1}^{t + 1} = {U}_{1}^{t} + {F}^{t + 1} - {Y}_{1}^{t + 1} & ( 43 ) \\ {U}_{2}^{t + 1} = {U}_{2}^{t} + {R}^{t + 1} - {Y}_{2}^{t + 1} & ( 44 ) \\ {U}_{3}^{t + 1} = {U}_{3}^{t} + {N}^{t + 1} - {Y}_{3}^{t + 1} & ( 45 ) \\ {U}_{4}^{t + 1} = {U}_{4}^{t} + G ∘ {C}^{T} ( {R}^{t + 1} + {F}^{t + 1} ) L + {N}^{t + 1} - M & ( 46 )\end{matrix}$$

Finally, the Y₃ update is given by a projection P_{σ},

Y₃^{t+1}=P_{σ}(N^{t+1}+U^{t}₃), (47)

where the projection defined as:

$${P}_{σ} ( y ) = \{ \begin{matrix}- 3 σ & if y \leq 3 σ \\ 3 σ & if y \geq 3 σ \\ y & otherwise\end{matrix} , \qquad ( 48 )$$

is applied to every entry of the matrix.

A second example function, for ease of reference, is herein referred to as the single-fluorophore model. When the target contains one fluorophore, the estimation problem is substantially simplified: The problem becomes biconvex in the unknown parameters wᵣ,wₓ and wₑ. It is possible to enforce the rank constraint rank(W)=1 by alternating minimization over subsets of parameters in which the objective is convex. Even though the solution model is iterative, it is easier to solve than the first function because the nuclear norm penalty is eliminated from the objective. In addition, the optimization is performed over a single excitation and emission spectrum, which allows imposition of non-negativity directly on the spectra. The single fluorophore optimization problem becomes:

$$\begin{matrix}minimize & {‖ M - {C}^{T} ( diag ( {Bw}_{r} ) + T ∘ {B}_{m} {w}_{m} {w}_{x}^{T} {B}_{x}^{T} ) L ‖}_{F}^{2} + \\ & β ( {‖ ∇ {B}_{x} {w}_{x} ‖}_{2}^{2} + {‖ ∇ {B}_{m} {w}_{m} ‖}_{2}^{2} ) + \\ & α {‖ ∇ {B}_{r} {w}_{r} ‖}_{2}^{2} \\ subject to & 0 \leq {Bw}_{r} \leq 1 , \\ & 0 \leq {B}_{x} {w}_{x} , \\ & 0 \leq {B}_{m} {w}_{m} ,\end{matrix} \qquad ( 48 )$$

The optimization is quadratic in wᵣ,wₘ and wᵣ,wₓ. First, a quadratic problem (QP) is solved over the variables wᵣ,wₘ holding wₓ's fixed. Next, a QP is solved over wᵣ, and wₓ while Wₘ is fixed. These steps are repeated until no improvement in the objective is observed.

In general, there is a scaling ambiguity in specifying the excitation and emission spectra, which are estimated up to a free multiplicative scale Δwₓ and (1/Δ)wₘ. Despite the scaling uncertainty, the model recovers the total number of fluoresced photons and their relative shapes.

A third example function, for ease of reference, is herein referred to as the chromaticity invariant model. In some instances, a fluorophore emits photons within one wavelength range, but is excited only by wavelengths below the emission wavelength range. This case permits a further simplification because the emission spectrum has the same chromaticity, independent of the light source. This case is modeled by optimizing over p=L^{T}Bₓwₓ, pεR^{j} rather than wₓ:

$$\begin{matrix}minimize & {‖ M - {C}^{T} ( diag ( {Bw}_{r} ) L + {B}_{m} {w}_{m} {p}^{T} ) ‖}_{F}^{2} + \\ & β {‖ ∇ {B}_{x} {w}_{x} ‖}_{2}^{2} + α {‖ ∇ {B}_{r} {w}_{r} ‖}_{2}^{2} \\ subject to & 0 \leq {Bw}_{r} \leq 1 \\ & 0 \leq {B}_{x} {w}_{x} \\ & 0 \leq p .\end{matrix} \qquad ( 49 )$$

In the chromaticity invariant model (CIM) only the shape of the fluorescence emission and an intensity scaling factor are estimated. The scaling factor pⱼ compactly represents all excitation phenomena for a given illuminant j. The wavelength dependency of the excitation spectrum is not included in the image formation model, as it is no longer meaningful to impose the Stokes shift theorem, and the matrix T is dropped.

In various experimental embodiments, the above-described functions are implemented. The multi-fluorophore, ADMM solver uses standard matrix operators, and the single fluorophore biconvex solver uses the cvx convex optimization toolbox. In specific embodiments, simulations are performed to understand the effect of key system parameters including (a) the number of basis excitation and emission basis functions, (b) the number of illuminants and filters, (c) the robustness to noise, and (d) function/model convergence rates.

To validate the estimation models, synthetic data is created that complies with the image formation model. Some embodiments include using a Macbeth chart reflectance spectra and Donaldson matrices from the McNamara-Boswell data set (restricted to samples with peak excitation wavelengths within the camera response range (380 to 1000 nm sampled at 4 nm, d=156)).

In some specific embodiments, it is identified that twelve fluorescence excitation and emission basis functions provide good approximations for the Donaldson matrix, and a system composed of about twenty channels and illuminants performs reliable reflectance and fluorescence separation. In addition, the function is robust against noise and converges to a solution typically in a few hundred iterations.

Further, in some specific embodiments, the approximation accuracy of excitation and emission spectra linear models with different number of basis functions, derived from the McNamara-Boswell dataset is analyzed using six basis to approximate Macbeth chart reflectances, which corresponds to the typically reported dimensionality of that set. A bispectral system, where camera samples spectral bands and the light source generates narrowband light in other words C=L=I, where IεR^{d×d} is the identity matrix used. Camera gain G are optionally adjusted to a maximal pixel intensity of one.

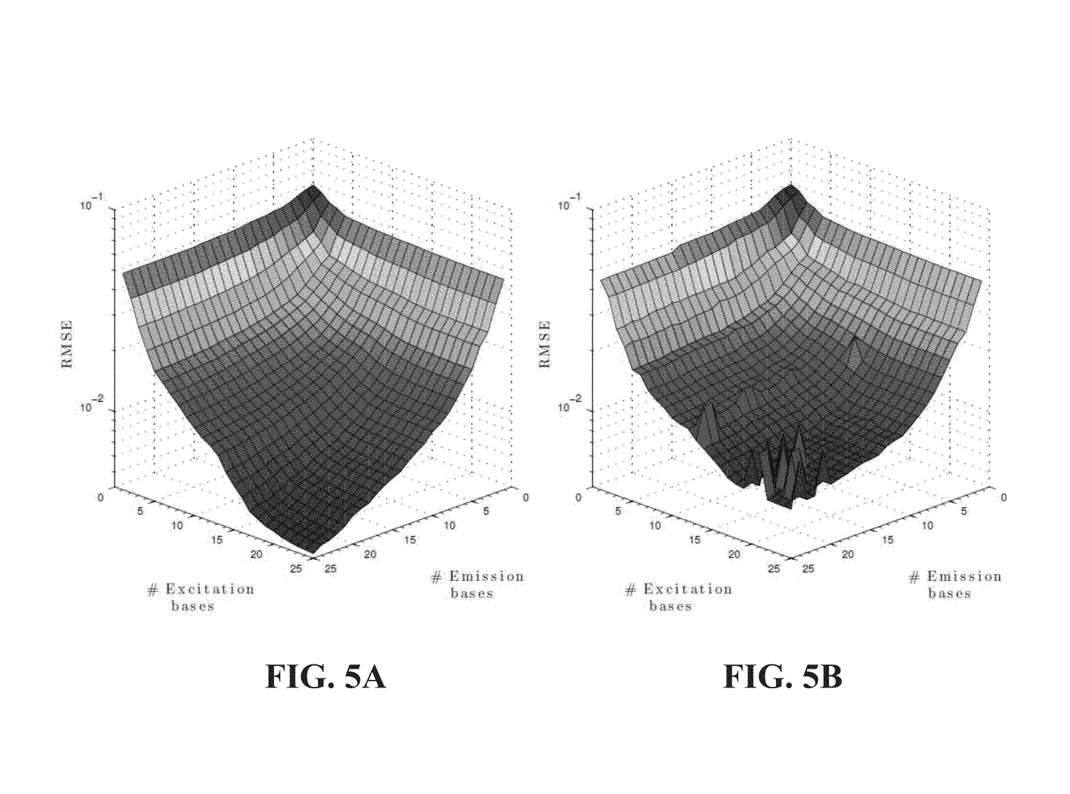

FIGS. 5A-5B show an example of the root-mean-square error (RMSE) of the Donaldson matrix estimates using the multi-fluorophore (FIG. 5A) and single fluorophore models (FIG. 5B). The values are averaged over ten different fluorophores and plotted as a function of the number of excitation and emission bases. Note that about twelve basis functions provide Donaldson matrix estimate RMSE of the order of 0.01. The camera and illuminant include 156 narrowband (4 nm) channels between 380 and 1000 nm.

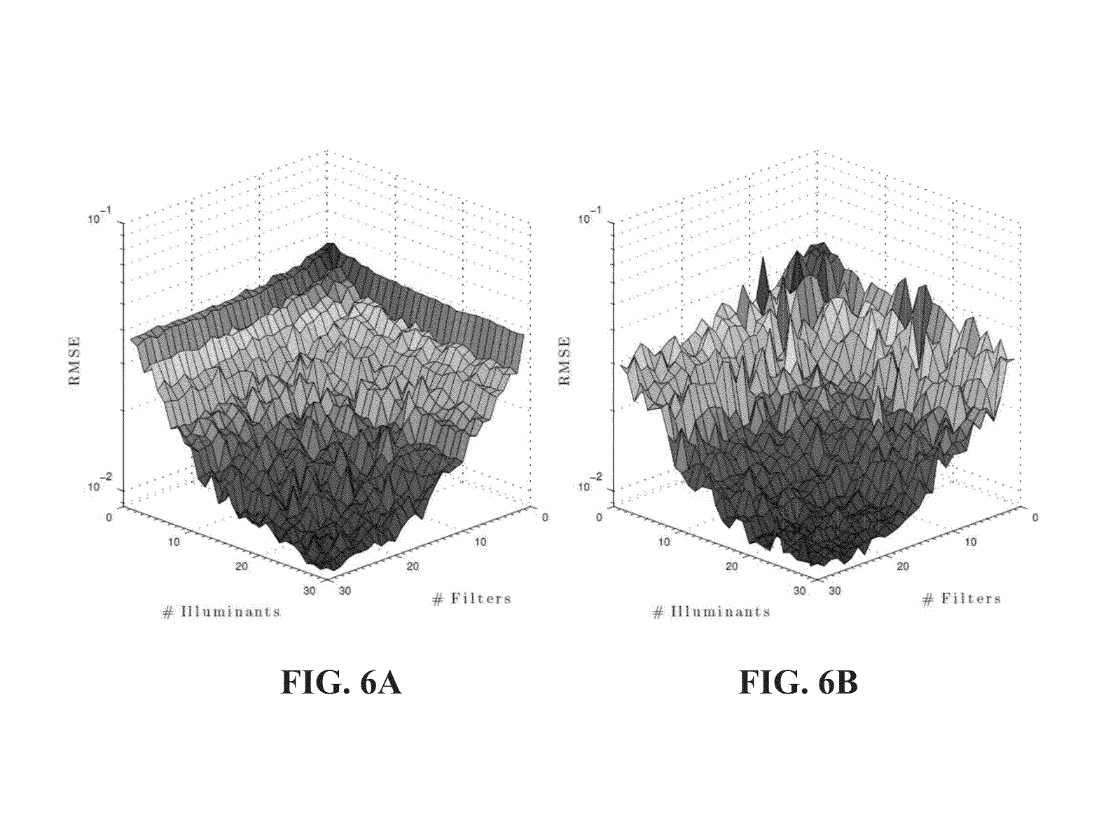

In accordance with a number of specific/experimental embodiments, the number of filters and illuminant channels are varied. Both filters and illuminant spectral profiles can be rectangular, and their widths are adjusted so that the sum of all channels produce a flat response over the entire spectral range. FIGS. 6A-6B show an example of the RMSE of the Donaldson matrix estimates averaged over 10 different fluorophores using the multi-fluorophore (FIG. 6A) and single fluorophore models (FIG. 6B). Note that the accuracy of fluorescence detection is effected by the spectral shapes and pass-band positions of camera filters and illuminants. This is why the error surfaces in FIGS. 6A-6B are less smooth, compared to those obtained by varying the number of basis functions. Using about twenty filters and illuminants produced RMSE on the order of 0.01. The number of linear bases used to approximate the excitation and emission spectra is set to twelve.

In accordance with a number of embodiments, the estimation accuracy in the presence of noise is analyzed. Different amounts of Gaussian noise are added to the simulated pixel intensities M. Simulations are performed using ten samples, each containing a single fluorophore. At each noise level and for each sample, eleven different instances of noise patterns are used, producing one-hundred and ten estimates per noise level.

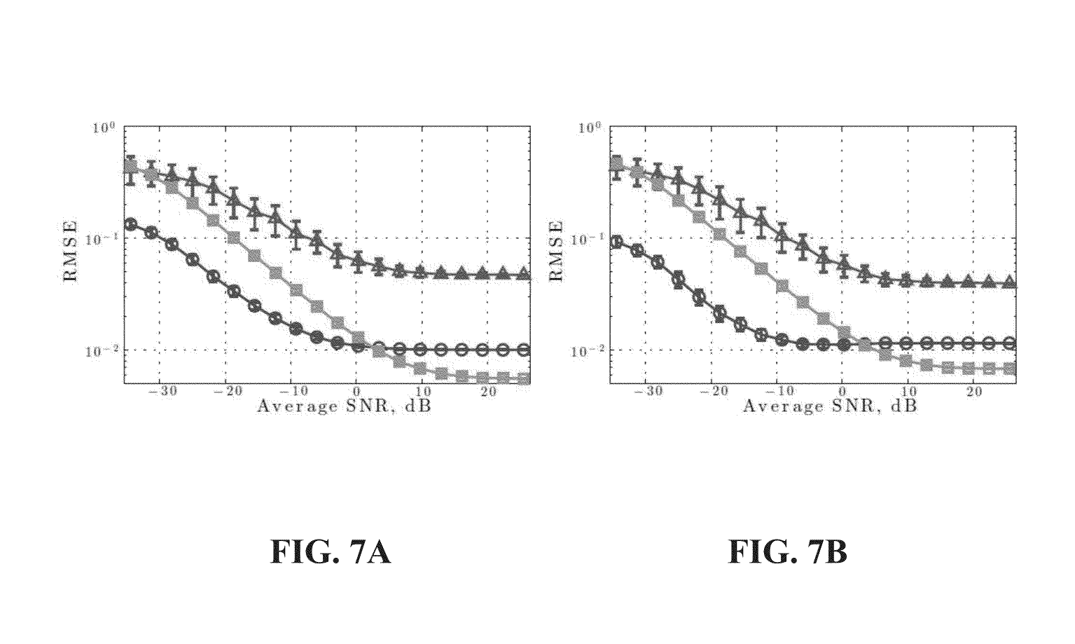

FIGS. 7A-7B show an example of the average RMSE of the Donaldson matrix, reflectance, and pixel values estimates as a function of the signal to noise ratio (SNR) using the multi-fluorophore (FIG. 7A) and single fluorophore models (FIG. 7B). Each curve is an average RMSE over ten samples and eleven noise instances. The error bars represent standard deviations computed for the eleven noise instances and averaged over ten samples. The accuracy asymptotes with the SNR reaching ten dB. In both cases the estimation accuracy asymptotes as SNR approaches ten dB. The separate curves indicate estimates of reflectance (Δ), Donaldson matrix (∘) and pixel values (□).

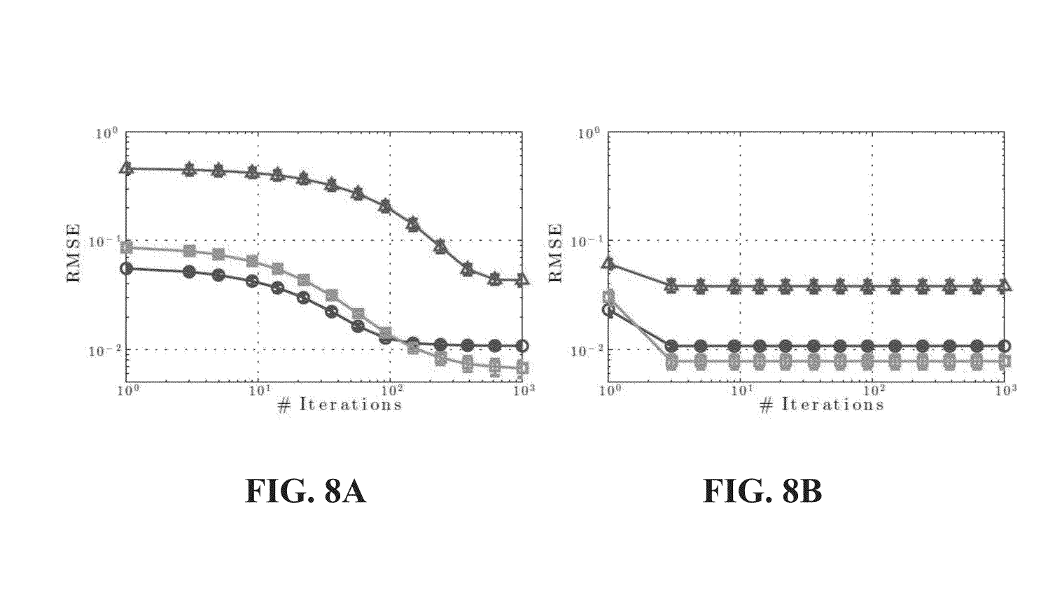

In accordance with a number of embodiments, the accuracy of estimation for different numbers of model iterations is observed. FIGS. 8A-8B show an example of the multi-fluorophore estimates RMSE as a function of the number of ADMM iterations as well as the biconvex estimates RMSE as a function of the number of biconvex iterations. FIG. 8A includes using the multi-fluorophore model and FIG. 8B includes using a single fluorophore model. All curves are averaged over estimates for ten different fluorophores and reflectance spectra. The multi and single fluorophore model estimates of the reflectance, Donaldson matrix and pixel values converge to approximately the same RMSE values. The multi-fluorophore model (FIG. 8A) converges to a solution more slowly than the single fluorophore model (FIG. 8B). The curves are RMSE of estimated reflectance (Δ), Donaldson matrix (∘) and pixel values (□).

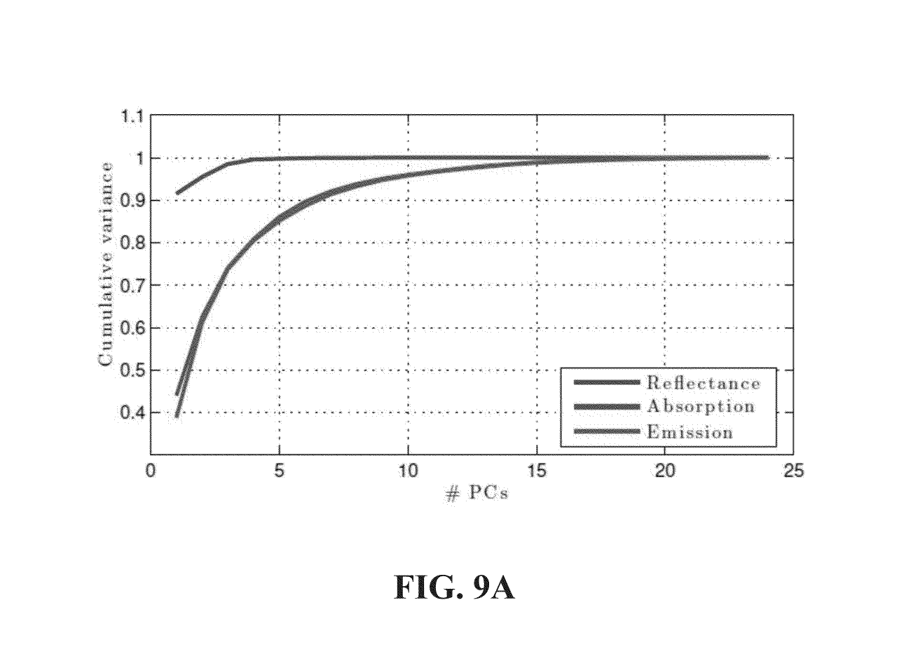

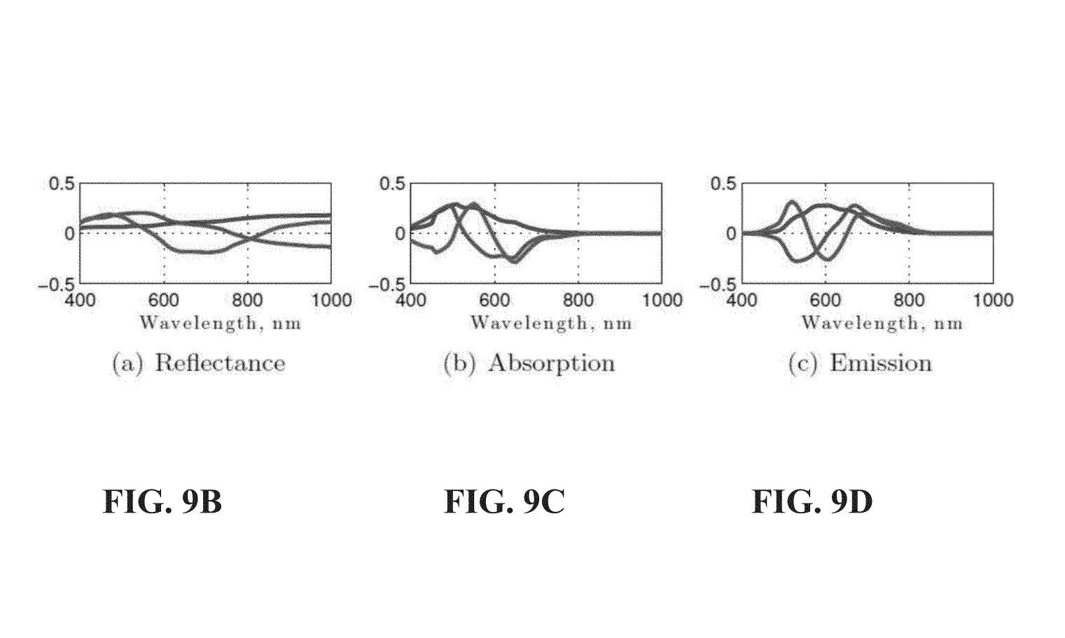

FIGS. 9A-9D show examples of spectral properties of a target. The spectral properties, as previously discussed, include reflectance and fluorescence properties. The fluorescence properties include both absorption and emission spectrums. FIG. 9A illustrates normalized variance of a dataset as a function of the number of principal components. In some embodiments, about five components are sufficient to explain variance in the data set composed of Macbeth chart reflectance. For fluorescence estimation, about twenty components are sufficient to explain both excitation and emission spectra. FIG. 9B-9D illustrate the first three vectors for each of the spectrum types. For example, FIG. 9B illustrates the first three vectors for a reflectance spectra. FIG. 9C illustrates the first three vectors for an absorption spectra. FIG. 9D illustrates the first three vectors for an emission spectra. Notably, the absorption and emission principal vectors are similar except for wave-shift.

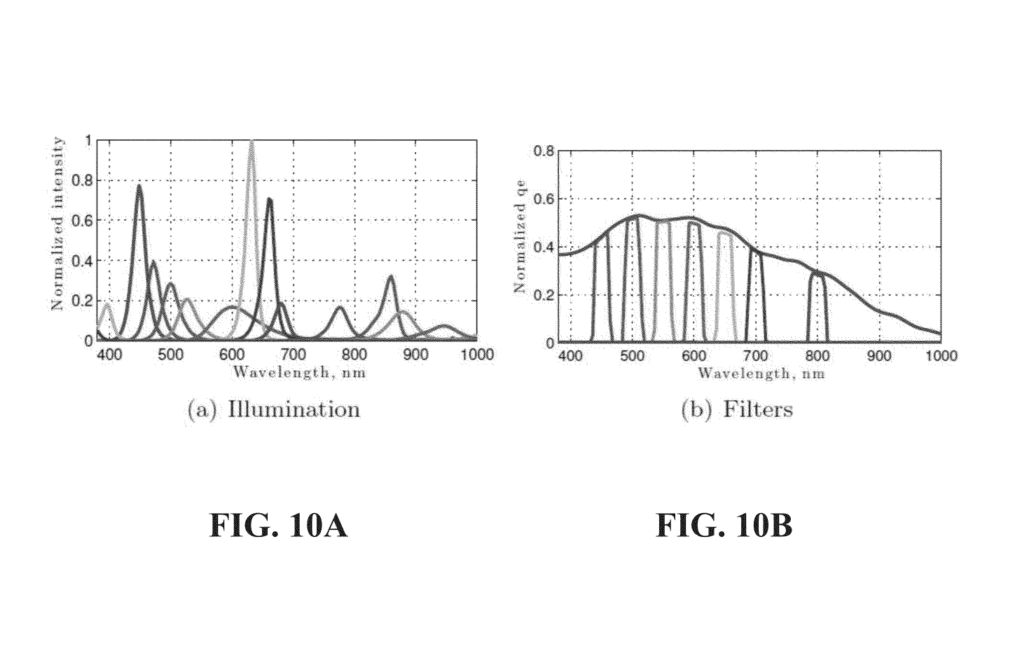

FIGS. 10A-10B show example wavelengths associated with illumination and filters of an example apparatus. In some detailed examples, the apparatus includes a monochrome, PointGrey Flea3 FL3-U3-13Y3M-C, 1.3MP camera with a Schneider Optics Tele-Xenar 70 mm lens. The camera acquires images through one broadband and seven 25 mm bandpass filters centered at 450, 500, 550, 600, 650, 700 and 800 nm. The filters are housed inside an Edmund Optics motorized filter wheel placed between the camera and the lens. The scenes are illuminated by one of fourteen narrowband, LED illuminants. The LEDs can include 350-400 nm peaks, the 400-700 nm peaks, and the 700-950 nm peaks. Filter wheel positions and illumination times are synchronized using timing controller circuitry. Non-uniform illumination is optionally corrected using an image of a white Spectralon target. As illustrated by FIG. 10A, the illumination provided by the illumination source is in a plurality of wavelength ranges across a spectrum (e.g., 350-1000 nm). As illustrated by FIG. 10B, the optical filter transmitts light in a plurality of spectral bands (e.g., different transmissivity ranges).

The joint (e.g., simultaneous) reflectance and fluorescence models extend to the methods described herein. Specifically, the estimation models work with samples containing multiple fluorophores, account for Stokes effect and estimate absolute amplitudes of reflected and fluoresced radiance.

In a number of specific embodiments, a custom fluorescence imaging system is used and different functions are applied to the measurements to evaluate and/or offer in practical settings, where noise, calibration accuracy and other sources of uncertainty are non-negligible. The functions are analyzed using image systems simulations, in various embodiments. The simulations analyze model performance with respect to properties that are difficult to control in experimental settings. Specifically, synthetic data is used to analyze how different values of the Stokes shift and fluorophore intensities affect estimation accuracy.

In various embodiments, a six basis function is derived from the set of Macbeth chart reflectance and twelve basis for excitation and emission spectra, derived from the McNamara-Boswell data set. The choice of tuning parameters (α, β and ν) can have little influence on the function/model accuracy over a broad range of values; therefore, the tuning parameters are adjusted manually, rather than through cross-validation.

The various models take a set of images acquired under different illuminants and through different filters as an input. Simulations show that the system approaches asymptotic performance using twenty filters and twenty illuminants. A simpler system can be used with eight different filters and fourteen LED illuminants with peak emission spectra in the 350 to 950 nm range.

The test target is composed of two elements. The first includes a reflective Macbeth color test chart. The second includes transparent fluorescent microscopy slides. The slides are placed on top of the Macbeth chart to create a target with reflectance and fluorescence properties. The properties are calibrated in the 380-1000 nm range in 4 nm bands by illuminating the target with monochromatic light generated by a monochromater (e.g., Oriel Cornerstone 130) and by measuring the surface radiance with a spectrophotometer. To separate the fluorescence and reflectance properties and to obtain reference ground truth data, the multi-fluorophore model is applied to the data set.

The simulated environment can be used to extend the range of the test stimuli. The Macbeth chart reflectance spectra is simulated with fluorescence excitation and emission properties from the McNamara-Boswell data set. Included fluorophores have different amounts of Stokes shift. In addition, optionally the emission spectra is scaled to evaluate the limits of fluorescent signal detection.

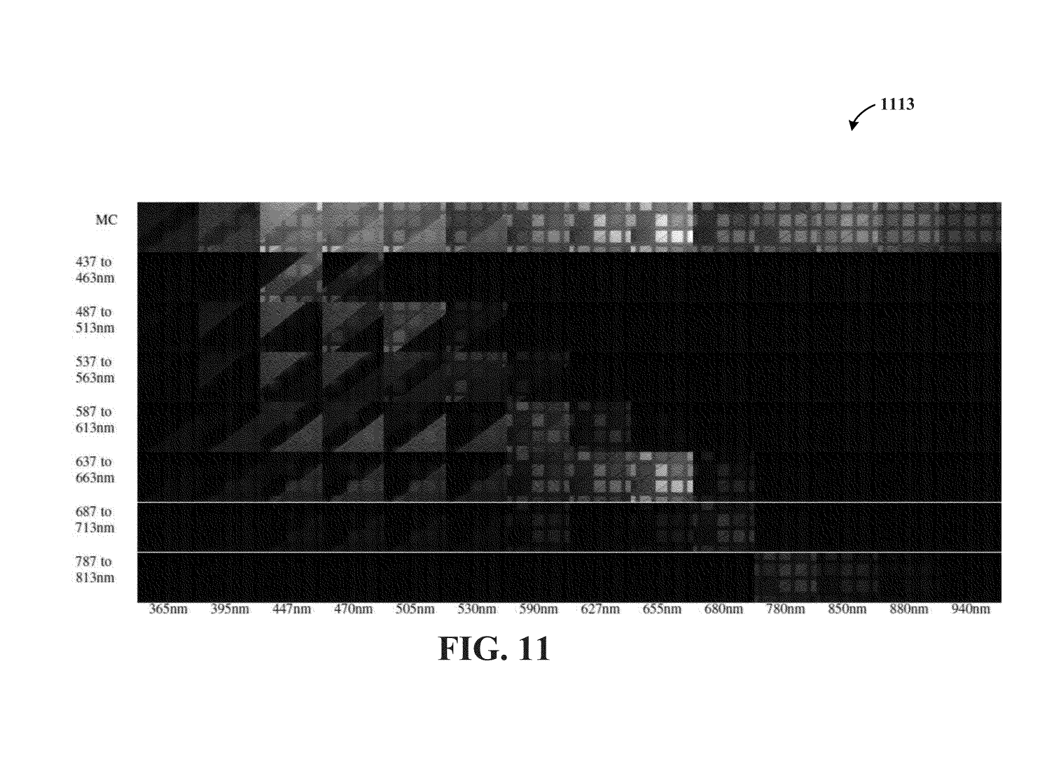

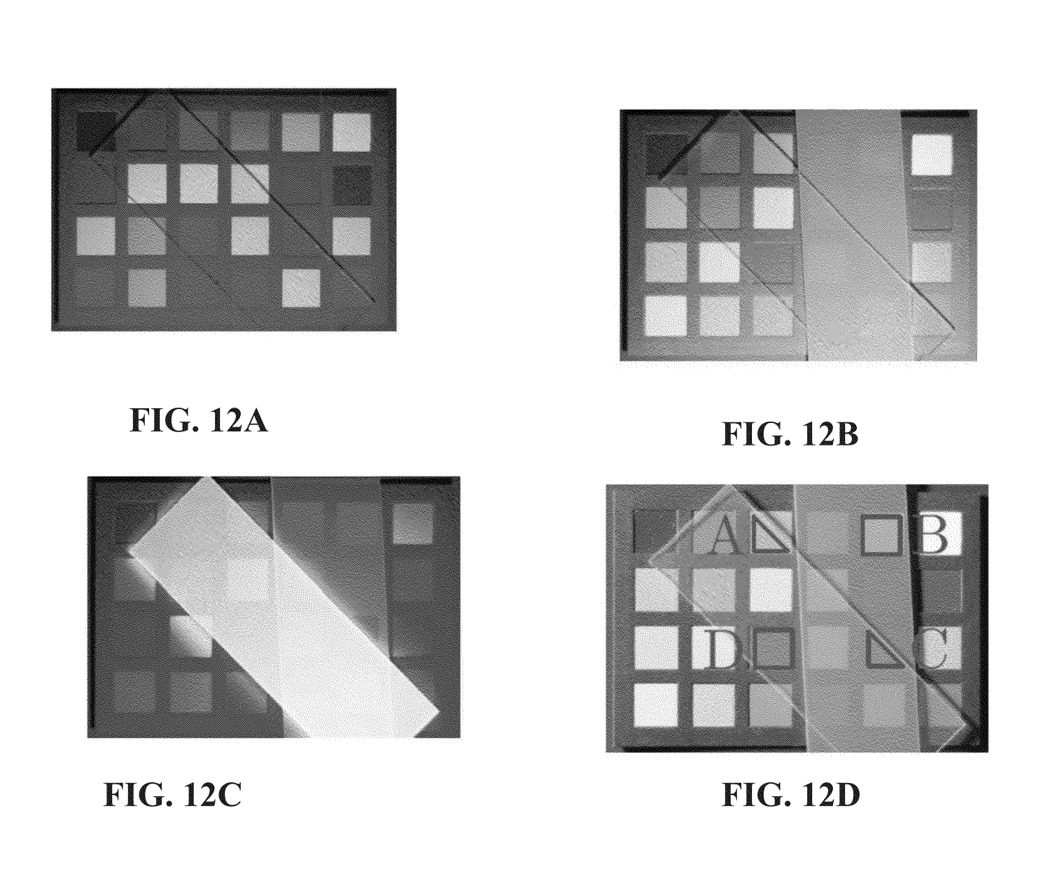

FIG. 11 shows an example of a collection 1113 of images acquired where a target scene is imaged under a specific illuminant (columns) and as seen through a filter. For example, rows represent different filters, with filter pass-bands specified next to each row, MC represents a broadband, monochrome sensor. Columns correspond to different illuminants with peak emission wavelengths given below each column. Nonzero images along the ‘diagonal’ represent the reflected component, while nonzero images ‘off diagonal’ captures the fluoresced component.

The top row of images shows the broadband, monochromatic response. The image matrix below shows seven×fourteen images. Those on the ‘diagonal’ are dominated by reflectance, and the ‘off-diagonal’ images measure fluorescence. The target chart illuminated with 447 nm through 530 nm light produces clear visible images in channels sensitive to wavelengths longer than the illumination.

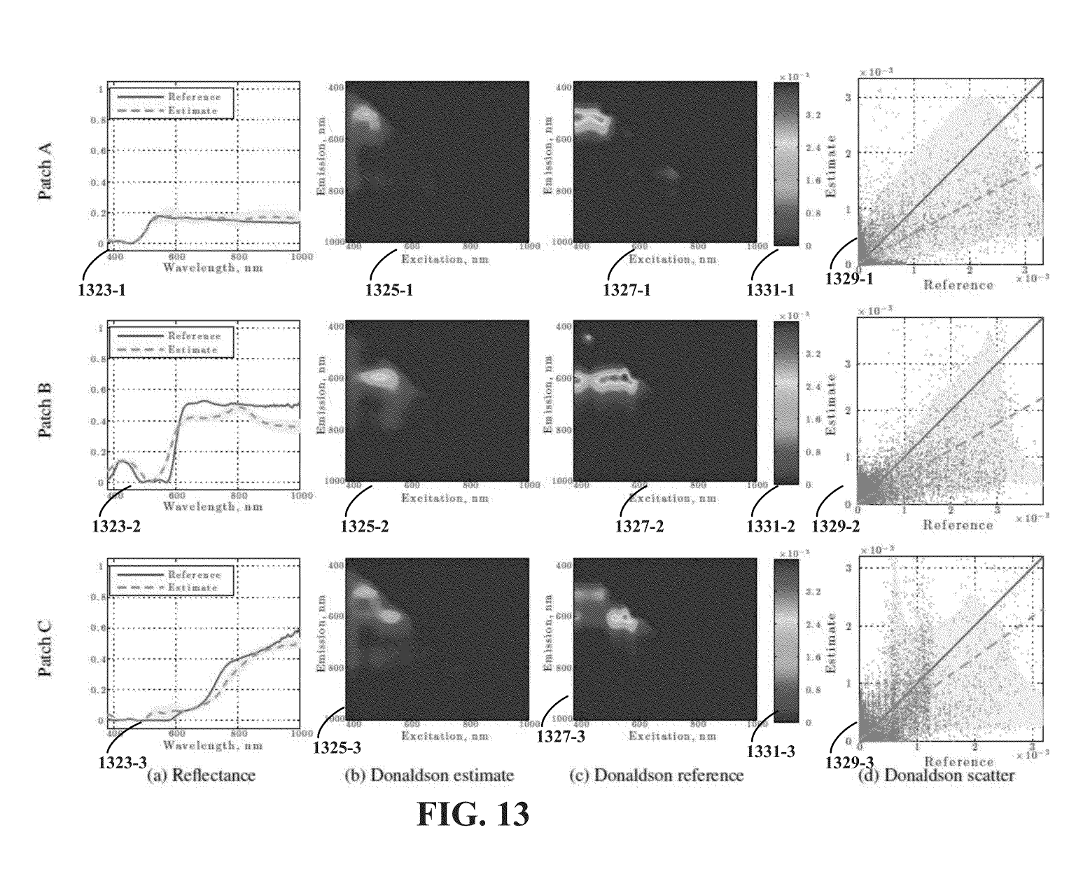

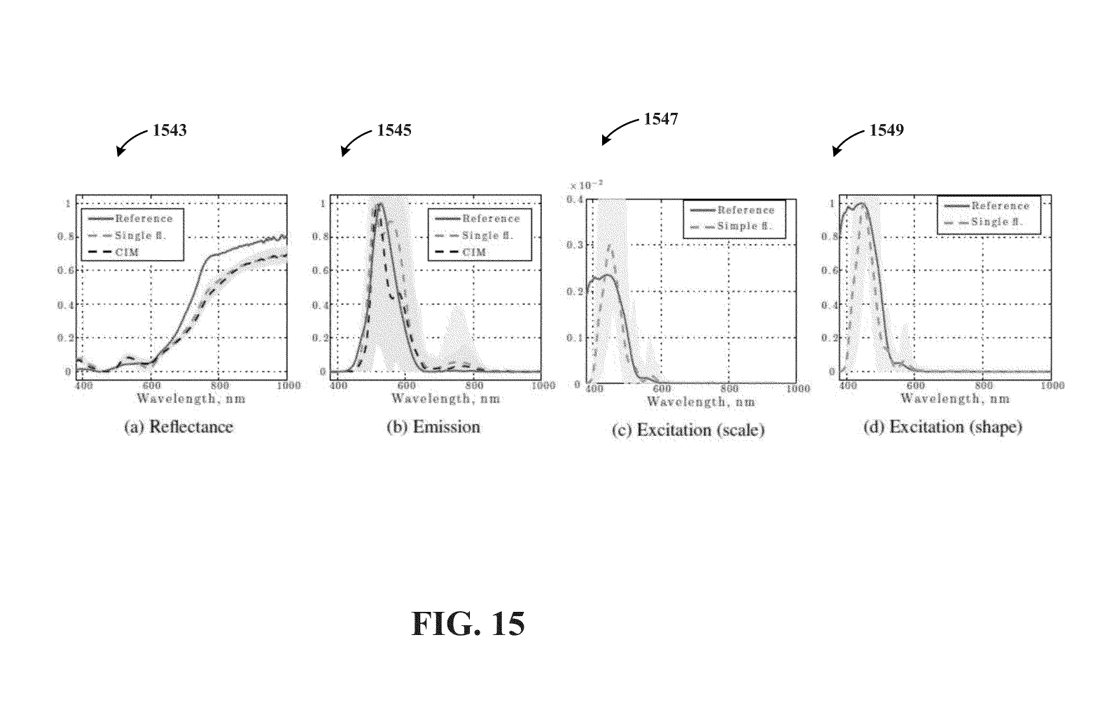

FIGS. 12A-12D show examples of conventional RGB camera images of the target when it was illuminated with lights in different spectral bands. FIG. 12A illustrates the target illuminated with red light, FIG. 12B illustrates the target illuminated with green light, FIG. 12C illustrates the targed illuminated with blue light, and FIG. 12D illustrates the target illuminated with tungsten light. These images show that the fluoresced components are best visible under green (FIG. B) and blue (FIG. C) light, for which the slides appear orange and green, respectively. FIG. 12A illustrates the fluorescent slides are transparent under red light. When illuminated with green and blue LEDs the slides emit photons in the red and green bands, respectively, as illustrated by FIGS. 12B and 12C. The reflectance and fluorescence of patches 12A-D are outlined are further analyzed in FIGS. 13 and 15.

The accuracy is evaluated by computing the root-mean-square error (RMSE) between estimated and ground truth spectral reflectance curves, Donaldson matrices and excitation and emission spectra. The average RMSE and standard deviation over estimates for all test patches in a given experiment are reported.

Note that these RMSE quantities typically occupy different ranges. The reflectance values are around 0.5, while the Donaldson matrix entries may rarely exceed 10⁻². Consequently, the low absolute values of the RMSE for the Donaldson matrix do not imply superior accuracy but simply capture the level of the fluorescence signal. All comparisons that preserve the absolute reflectance or fluorescence scales are herein referred to as the intensity comparisons. To better match the RMSE scales, the RMSE for normalized quantities is computed which is herein referred to as shape comparisons. In this case, the estimate and ground truth are divided by their maximal values before computing the RMSE.

Finally, a bootstrapping to calculate the 95% confidence intervals on the estimated curves is performed. Given a particular test patch, the estimation models are run one-hundred times using pixel values randomly selected from the image area representing that patch. Confidence interval boundaries are given by the 2.5th and 97.5th percentiles of estimate distributions at a particular wavelength.

FIG. 13 illustrates an example of multi-fluorophore estimation results for patches A, B and C outlined in FIG. 11. Columns show the estimates and ground truth reference for reflectance (a) (e.g., 1323-1, 1323-2, 1323-3) and the Donaldson matrix (b,c) (e.g., 1325-1, 1325-2, 1325-3, 1327-1, 1327-2, 1327-3) and a scaled by a range of values (e.g., 1331-1, 1331-2, 1331-3). Column (d) (e.g., 1329-1, 1329-2, 1329-3) presents scatter plots and a linear fit (green dashed line) between estimated and ground truth Donaldson matrix entries. Shaded areas denote the 95% confidence intervals. Patches A and B contain a single fluorophore, while patch C includes two fluorophores. The Donaldson matrix estimate for patch C is a weighted sum of the Donaldson matrices for patches A and B.

The multi-fluorophore model is performed, in specific embodiments, using fourteen test patches containing one or two different fluorophores (Table 1). FIG. 13 shows spectral estimates and ground truth data for three patches outlined on the test chart presented in FIG. 12. Patches A and B contain ‘red’ and ‘green’ fluorophores respectively, while patch C contains both fluorophores. The multi-fluorophore model approximates the shape of the surface reflectance (left graphs). The Donaldson matrix for patches A and B have emission peaks at 500 nm and 600 nm respectively. The Donaldson matrix estimate for the patch C containing both ‘red’ and ‘green’ fluorescence compounds and is bimodal with emission peaks at both 500 nm and 600 nm, reflecting the signals from the two fluorophores.

TABLE 1

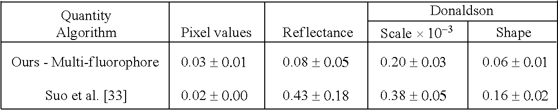

Table one illustrates the multi-fluorophore estimation model's average RMSE and corresponding standard deviation.

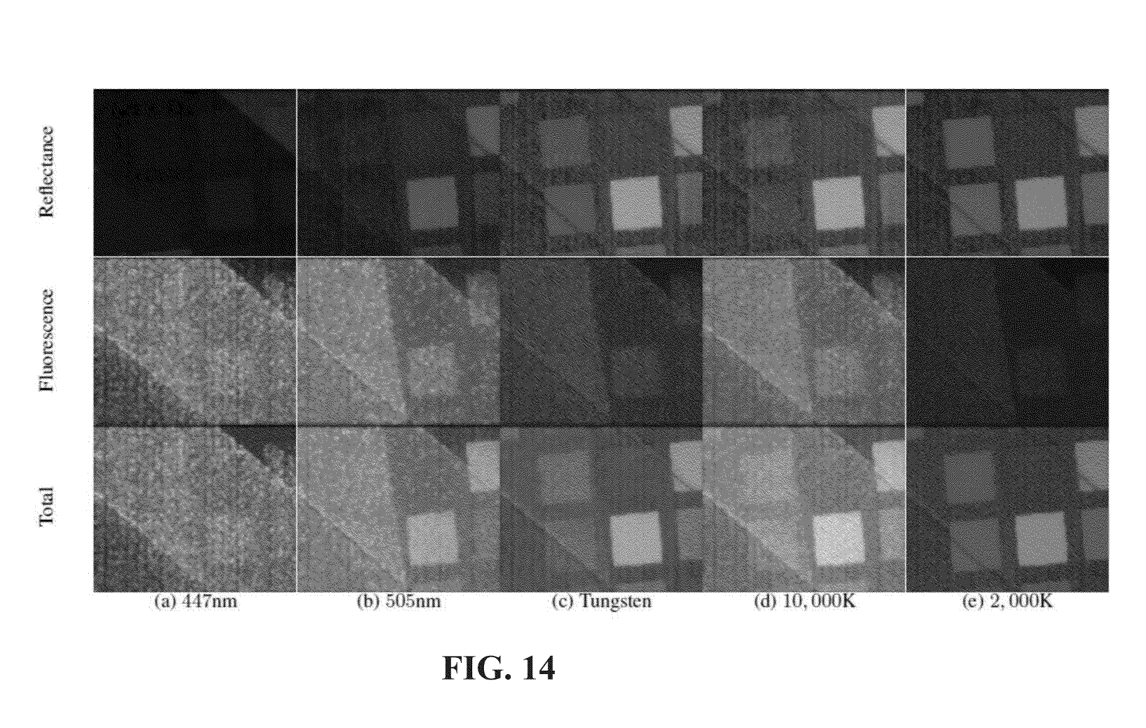

The estimated reflectance and fluorescence spectrums can be used to perform realistic scene relighting or component separation as shown in FIG. 14. For narrowband, short wavelength illuminants the total radiance can be dominated by the fluoresced component. This component is captured by a camera when, for example, broadband tungsten light is used, even though it can be dominated by the reflected component.

FIG. 14 shows an example of fluoresced and reflected radiance separation and relighting. The images are synthesized from reflectance and fluorescence estimates of a target (multi-fluorophore model). Rows present the appearance of reflected (top), fluoresced (middle), and total (bottom) radiances. The columns show the synthesized images assuming a series of different lights. Columns (a,b) are narrowband lights and (c-e) are broadband lights at different color temperatures.

When the reflectance and fluorescence properties are estimated for all pixels in the scene, realistic scene relighting or component separation can be performed. FIG. 14 illustrates reflected, fluoresced and total radiance, under different illuminants from a target properties whose properties were estimated under realistic (noisy) conditions and using the multi-fluorophore model. Blue, 447 nm light excites fluorescence primarily in the green slide, while the green 505 nm excitation light increases response in the red slide. Also, the fluoresced component, though present in all illumination conditions, dominates the total radiance for narrowband, short wavelength illuminants (columns a and b). The contribution of the fluoresced component varies with the color temperature of the broadband light source (columns c-e).

FIG. 15 shows an example of the estimated reflectance and fluorescence excitation and emission spectra of path D of FIG. 11 estimated using the single fluorophore and CIM models. The ground truth spectral curves for the fluorescence terms fall within the 95% confidence interval ranges, but the models underestimate surface reflectance properties in the longer wavelength range. Table 2 summarizes the average error (RMSE) over 15 test patches. The single fluorophore and CIM models achieve similar RMSE scores. By definition, the CIM approach does not recover the excitation spectrum. Each panel compares true (solid) and estimated (dashed) reflectance 1543, emission 1545, excitation scale 1547, and excitation shape 1549. The shaded areas represent 95% confidence intervals around the estimates.

TABLE 2

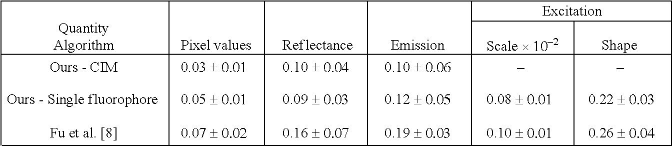

Table 2 illustrates a comparison of single fluorophore model and the CIM model. The RMSE±1 standard deviation are shown. There is a scaling ambiguity between the excitation and emission spectra; without loss of generality we assume that the peak emission spectrum is scaled to a value of 1 and that the fluorescence intensity is contained within the scale of the excitation spectrum. Hence, the RMSE of the excitation estimate with and without scaling, but there is no need to do so for the emission spectrum.

As previously discussed, in various embodiments, simulation environment (to analyze system performance with respect to properties that are difficult to control in experimental settings) is used. The simulated test targets combined the Macbeth chart reflectance spectra with fluorescence excitation and emission properties from the McNamara-Boswell data set. Using synthetic data, different values of the Stokes shift and fluorophore intensities are investigated with regard to affect an estimation accuracy. The emission spectra is optionally scaled to evaluate the limits of low intensity fluorescent signal detection.

In a number of detailed embodiments, four test charts that contained fluorophores with different separations between excitation and emission peaks are used. Each chart contains fluorophores in which the separations between excitation and emission peaks are assigned to four clusters: 0 nm to 25 nm, 25 nm to 50 nm, 50 nm to 75 nm and 75 nm to 100 nm. When the separation is small the wavelengths of emitted photons are close to the exciting photons, and fluorescence properties approach that of a reflective surface.

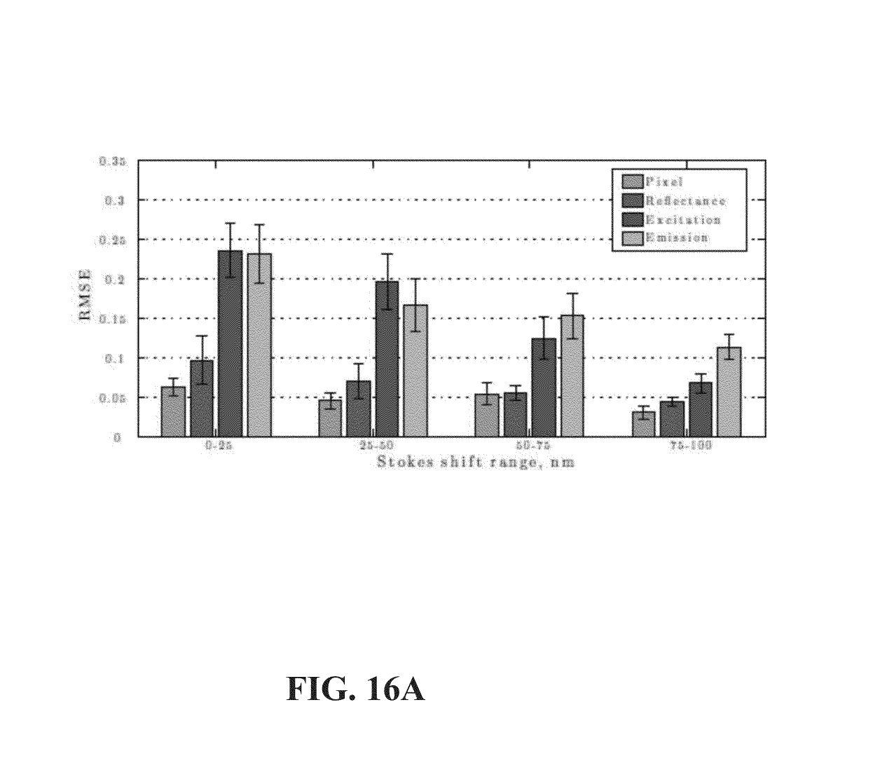

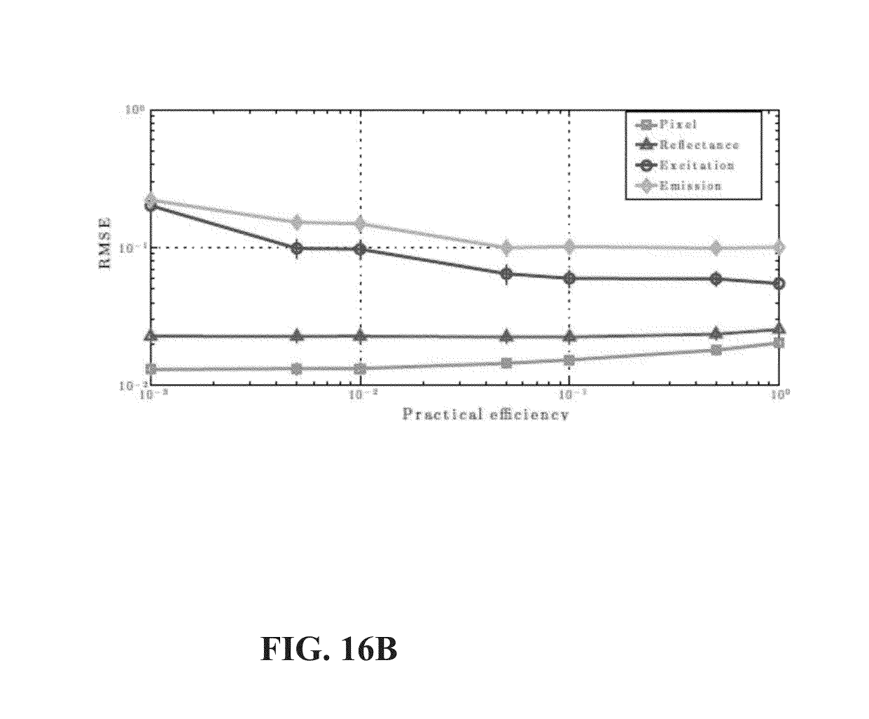

FIG. 16A illustrates an example of the average RMSE for spectral reflectance, excitation and emission spectra estimates declines as the bands separate. The RMSE decrease indicates that the disambiguation between reflected and fluoresced components can be better. Across all conditions the measured pixel intensities RMSE is in the five-percent range. For example, the estimation errors of normalized quantities (shape comparisons) for fluorescent compounds with different Stokes shift are illustrated by FIG. 16A. The RMSE values decrease as the Stokes shift increases. The separation makes it easier to resolve reflected and fluorescent components.

In various embodiments, the model performance is evaluated using fluorescence signals of different intensities. For example, the fluorophores' practical efficiency is varied, which relates the amount of fluoresced photons to the amount of photons incident on, rather than absorbed by a surface. This term measures the proportion of the total number photons reaching camera's sensor that are due to fluorescence emission.

The average RMSE of emission and normalized excitation spectra estimates decline as a function of practical efficiency (FIG. 16B). Reflectance and pixel value RMSE are within five-percent for this range of fluorophore practical efficiency. That is, FIG. 16B illustrates an example of RMSE as the practical efficiency of the fluorescent component increases. Excitation and emission spectra RMSE increases when the fluoresced to reflected radiance ratio drops below 0.01.

Embodiments in accordance with the present disclosure include joint reflectance and fluorescence estimation framework that unifies multi-fluorophore and single fluorophore applications, as well as applications in which the excitation and emission bands overlap. Simulations show that the models can use twelve excitation and emission basis functions and about twenty camera channels and illuminants to provide accurate estimates of the reflected and fluoresced components in typical data sets. Furthermore, the iterative models converge to a solution in a few hundred iterations. When applied to real data from an implemented apparatus, the model estimates reflectance to an RMSE of about five-percent, captures the peak emissions of the Donaldson matrix (FIG. 13), and the shapes of the excitation and emission spectra (FIG. 15).

Example embodiments minimizes the error between measured and estimated pixel intensities but does not impose hard constraints. Despite larger differences between measured and predicted pixel values, spectra are accurately estimated. The single fluorophore model and chromaticity invariant (CIM) methods have lower RMSE errors compared to other approaches. The performance improvement can be attributed to solving for all the unknowns in a single optimization.

In some embodiments, the estimation results using the chosen fourteen illuminants and eight channels accurately estimate the Donaldson matrix peak positions, but may not precisely estimate the shape (FIG. 13, Donaldson scatter plots). Increasing the number of imaging channels and/or illuminants increases the estimation accuracy (FIG. 7). Therefore, the accuracy is limited by the image acquisition hardware, rather than the models.

In some cases (e.g., FIG. 15), the model underestimates surface reflectance in the longer wavelength range. Some of these errors can be explained by limitations of the imaging hardware; fewer sampling channels above 700 nm, low silicon responsivity in the near-infrared (NIR) range (e.g., FIG. 10B) and camera's firmware constraints on the maximal allowed exposure settings. Consequently, the SNR in the NIR channels is lower than in the channels that span the visible range. Furthermore, to determine the correct scales of fluoresced and reflected radiances, the camera has to be accurately calibrated over all ranges of gain (ISO), photo response non-uniformity, shutter speed and aperture settings. Small calibration errors translate to poor estimation of spectral properties.

Noise in the input data becomes more visible when all pixels in an image are analyzed, as the models perform spectral estimation independently for each pixel. Some of the noise patterns visible in FIG. 14 have vertical structure due to inaccurate fixed pattern noise calibration of the camera used in the acquisition system. The amount of noise can be reduced by introducing spatial components into the models, such as total variation priors.

Fluorescence estimation errors begin to increase when the fluorescent signal is about one-hundred times weaker than the total radiance reaching the sensor. Given a somewhat noisy, 8 bit CMOS sensor simulated, this level is comparable to the noise floor of the imaging system. This indicates that model detection and estimation capabilities are limited by the dynamic range of the photodetector arrangement.

Thereby, embodiments include a unified framework for joint/simultaneous estimation of reflectance and fluorescence properties. These properties can be derived from a small number of images taken with different narrowband filters and under narrowband illuminants. The image formation model accounts for multiple fluorophores and the Stokes effect.

The estimation model may be simplified when it is know in advance that a single fluorophore (single fluorophore) is present or if only the fluorescence emission is of interest (CIM). The model is optionally adjusted to account for additional illuminants, imaging filters or knowledge about the properties of the imaged target. For example, in many biological applications samples are stained with known fluorophores and only their concentrations need to be quantified. This prior knowledge can be incorporated into the framework by adding equality constraints on the fluorescence spectrum coefficients and using the same models and approaches to find a solution to the problem.

Various embodiments are implemented in accordance with the underlying Provisional Application (Ser. No. 62/068,191) to which benefit is claimed and which is fully incorporated herein by reference. For instance, embodiments herein and/or in the provisional application (including the appendices therein) may be combined in varying degrees (including wholly). Reference may also be made to the experimental teachings and underlying references provided in the underlying provisional application, including the Appendix that form part of the provisional application. Embodiments discussed in the Appendix are not intended, in any way, to be limiting to the overall technical disclosure, or to any part of the claimed invention unless specifically noted.

The Appendix of the underlying Provisional Application is hereby fully incorporated by reference for its general and specific teachings. The Appendix entitled “Simultaneous Reflectance and Fluorescence Estimation,” generally and specifically describes apparatus and methods of jointly estimating reflectance and fluorescence and illustrates a number of different ways of representing the models as illustrated herein. This document is fully incorporated herein by reference for its teachings (including background references cited therein and which disclose applications beneficial to aspects of the present disclosure), generally and specifically, to the structures, circuitry, imaging apparatuses and processes described and shown therein.

Various blocks, modules or other circuits may be implemented to carry out one or more of the operations and activities described herein and/or shown in the figures. In these contexts, a “block” (also sometimes “logic circuitry” or “module”) is a circuit that carries out one or more of these or related operations/activities (e.g., the circuitry and diagrams shown in FIG. 1A). For example, in certain of the above-discussed embodiments, one or more modules are discrete logic circuits or programmable logic circuits configured and arranged for implementing these operations/activities, as in the circuit modules, processing computer and controller shown in FIG. 1A. In certain embodiments, such a programmable circuit is one or more computer circuits programmed to execute a set (or sets) of instructions (and/or configuration data). The instructions (and/or configuration data) can be in the form of firmware or software stored in and accessible from a memory (circuit). As an example, first and second modules include a combination of a CPU hardware-based circuit and a set of instructions in the form of firmware, where the first module includes a first CPU hardware circuit with one set of instructions and the second module includes a second CPU hardware circuit with another set of instructions.

Certain embodiments are directed to a computer program product (e.g., nonvolatile memory device), which includes a machine or computer-readable medium having stored thereon instructions which may be executed by a computer (or other electronic device) to perform these operations/activities.

Based upon the above discussion and illustrations, those skilled in the art will readily recognize that various modifications and changes may be made to the various embodiments without strictly following the exemplary embodiments and applications illustrated and described herein. Such modifications do not depart from the true spirit and scope of various aspects of the invention, including aspects set forth in the provisional claims.

What is claimed is:

1. A method comprising:
providing captured intensity characteristics indicative of a target, the intensity characteristics acquired by illuminating the target with different illuminants and passing light in different spectral bands via a photodetector apparatus;
providing reflectance properties and fluorescent properties of the target;
concurrently adjusting the reflectance properties and fluorescence properties to reduce a quantity indicative of a combination of:
a difference between the captured intensity characteristics and intensities predicted using an image formation model incorporating the reflectance properties and fluorescence properties;
functions of the reflectance properties; and
functions of the fluorescence properties; and
outputting a reflectance spectra estimation and a fluorescent spectra estimation for the fluorophore based on the adjusted reflectance properties and fluorescence properties.

2. The method of claim 1, wherein concurrently adjusting the reflectance properties and fluorescence properties includes iteratively adjusting the reflectance properties and fluorescence properties to minimize a weighted sum of an error between the captured intensity characteristics and intensities predicted using the image formation model incorporating the reflectance properties and fluorescence properties, the functions of the reflectance properties, and the functions of the fluorescence properties.

3. The method of claim 1, wherein the fluorescent properties are generated by more than one fluorophore and wherein outputting said reflectance spectra estimation and fluorescence spectra estimation includes outputting a reflectance spectra estimation and fluorescence spectra estimation for each of a plurality of fluorophores in the target.

4. The method of claim 1, wherein the function of the reflectance properties includes a smoothness function of the reflectance properties of the reflectance spectra and the functions of the fluorescence properties includes a smoothness function of the fluorescence properties of the fluorescence spectra.

5. The method of claim 1, wherein providing the captured intensity characteristics includes receiving a set of images of the target acquired under the different illuminants and captured using the photodetector apparatus configured to capture the intensity characteristics in the different spectral bands.

6. The method of claim 1, wherein reducing the quantity further includes minimizing a weight of a nuclear norm of a fluorophore matrix comprised of the fluorescence properties.

7. The method of claim 1, further including providing the captured intensity characteristics in a matrix where the (i, j) entry represents the intensity characteristics captured with the ith spectral channel of the photodetector arrangement under the jth illuminant.

8. The method of claim 1, wherein the image formation model include spectral properties of the photodetector arrangement and spectral power distributions of light, the method further including:
providing the spectral properties of the photodetector arrangement in a matrix where the (i,j) entry represents sensitivity of the ith spectral channel of the photodetector arrangement to passed light in the jth spectral band; and
providing the spectral power distributions of light in a matrix where the (i,j) entry represents the amount of light emitted by the jth illuminant in the ith spectral band.

9. The method of claim 1, further including:
providing the fluorescence properties in a square matrix where the (i,j) entry represents the amount of light emitted by the fluorophore in the ith spectral band when illuminated with a light wavelength from the jth illuminant; and
providing the reflectance properties in a vector, where the ith vector entry represents the amount of light reflected in the ith spectral band.

10. The method of claim 1, wherein reducing the quantity includes adding additional constraints on the values of the reflectance and fluorescence properties, and the additional constraints including the values are non-negative.

11. An apparatus comprising:
an illumination source configured to illuminate a target by directing a plurality of different illuminants toward the target, the plurality of different illuminants spanning a spectrum;
a photodetector arrangement, including a photodetector circuit, configured to selectively pass light in each of a plurality of different spectral bands to the photodetector circuit, wherein the photodetector circuit is configured to capture intensity characteristics indicative of a fluorophore of the target acquired in the plurality of different spectral bands and under the plurality of different illuminations; and
processing circuitry configured and arranged to:
provide reflectance properties and fluorescent properties of the target;
concurrently adjust the reflectance properties and fluorescence properties to reduce a quantity indicative of a combination of:
a difference between the captured intensity characteristics and intensities predicted using an image formation model incorporating the reflectance properties and fluorescence properties;
functions of the reflectance properties; and
functions of the fluorescence properties; and
output a reflectance spectra estimation and a fluorescent spectra estimation for the fluorophore based on the adjusted reflectance properties and fluorescence properties.

12. The apparatus of claim 11, wherein the processing circuitry is configured to concurrently adjust the reflectance properties and fluorescence properties by iteratively adjusting the reflectance properties and fluorescence properties to minimize the quantity indicative of the combination of the difference between the captured intensity characteristics and intensities predicted using the image formation model incorporating the reflectance properties and fluorescence properties, the functions of the reflectance properties, and the functions of the fluorescence properties.

13. The apparatus of claim 11, wherein the functions of the reflectance properties and the fluorescence properties include functions selected from the group consisting of: a smoothness function of a vector computed as a p-norm of the difference between adjacent vector entries and a smoothness function of a matrix computed columns and/or rows of the matrix.

14. The apparatus of claim 11, wherein the processing circuitry is configured to provide the reflectance properties and fluorescent properties using pseudo-random technique.

15. The apparatus of claim 11, wherein the function of the reflectance properties includes a smoothness function of the reflectance properties of the reflectance spectra and the functions of the fluorescence properties includes a smoothness function of the fluorescence properties of the fluorescence spectra and a nuclear norm of a fluorophore matrix comprised of the fluorescence properties.

16. The apparatus of claim 11, wherein the fluorescent properties are generated by more than one fluorophore, and the processing circuitry is configured to output a reflectance spectra estimation and fluorescence spectra estimation for each of the fluorophores in the target.

17. The apparatus of claim 11, wherein the processing circuitry is configured to reduce the quantity by:
minimizing the sum of an error between the captured intensity characteristics and intensities predicted using the image formation model indicative of the reflectance properties and the smoothness function of the reflectance properties, followed by minimizing the sum of an error between the captured intensity characteristics and intensities predicted using the image formation model indicative of the fluorescence properties and the smoothness function of the fluorescence properties.

18. The apparatus of claim 11, wherein the processing circuitry is configured to reduce the quantity by:
minimizing the sum of an error between the captured intensity characteristics and intensities predicted using the image formation model indicative of the fluorescence properties and the smoothness function of the fluorescence properties, followed by minimizing the sum of an error between the captured intensity characteristics and intensities predicted using the image formation model indicative of the reflectance properties and the smoothness function of the reflectance properties.

19. An apparatus comprising:
an illumination source configured to illuminate a target by providing a plurality of different illuminants toward the target, the plurality of different illuminants spanning a spectrum;
a photodetector arrangement, including a photodetector circuit, configured to selectively pass light in each of a plurality of different spectral bands to the photodetector circuit, wherein the photodetector circuit is configured to capture intensity characteristics indicative of a fluorophore of the target acquired in the plurality of different spectral bands and under the plurality of different illuminations; and
processing circuitry configured and arranged to:
for each of the different spectral bands, using the captured intensity characteristics to provide component entries that correspond to and characterize fluorescence and reflectance contributions in each of the different spectral bands and in response to the provided component entries, concurrently computing components indicative of reflectance spectra estimation and fluorescence spectra estimation based on the captured intensity characteristics of the selectively passed light in the different spectral bands and based on the computed components having a smoothness function relative to adjacent ones of the different spectral bands;
selecting, among the concurrently computing components in each of the different spectral bands, which ones of the concurrently computed components are likely to be indicative of reflectance spectra estimation and fluorescence spectra estimation for a fluorophore in the target; and
outputting said reflectance spectra estimation and fluorescence spectra estimation for the fluorophore in the target using the selected components.

20. The apparatus of claim 19, wherein the component entries that correspond to and characterize reflectance contributions include an amount of light reflected in the particular spectral band and the component entries that correspond to and characterize fluorescence contributions include an amount of light emitted in the particular spectral band when illuminated with a particular illuminant having a light wavelength.

21. The apparatus of claim 19, wherein the processing circuitry is configured to output a reflectance spectra estimation that describes a fraction of incident reflected photons that are reflected at each wavelength of the fluorescence signal spectrum and output a fluorescence spectra estimation that describes light absorbed by the target in a first sub-set of wavelengths of the fluorescence signal spectrum and emitted photons that are re-emitted at a second subset of the wavelengths of the fluorescence signal spectrum.

22. The apparatus of claim 19, wherein the photodetector circuit is configured and arranged to capture a series of images of the target using the selectively passed light in each of the different spectral bands and wherein the captured intensity characteristics includes pixel intensity of the series of images.

23. The apparatus of claim 19, wherein the target has only one fluorophore.

24. The apparatus of claim 19, wherein the target has a plurality of different fluorophores, and the processing circuitry is configured to jointly provide component entries, concurrently compute components indicative of reflectance spectra estimation and fluorescence spectra estimation, select concurrently computed components, and output a reflectance spectra estimation and fluorescence spectra estimation for each of the plurality of different fluorophores in the target.

25. The apparatus of claim 24, wherein the processing circuitry is configured and arranged to select which ones of the concurrently computed components by iteratively minimizing a weighted sum of an error between the captured intensity characteristics and intensities predicted by an image formation model incorporating the computed components, the smoothness function relative to adjacent ones of the different spectral bands, and a weighted nuclear norm of the matrix entries that correspond to and characterize fluorescence contributions.

26. The apparatus of claim 19, wherein the photodetector arrangement further includes an optical filter and a lens, the optical filter being arranged in an optical path between the photodetector circuit and the target, and the filter and the lens being configured to selectively pass light in each of the different spectral bands to the photodetector circuit.

27. The apparatus of claim 26, wherein the optical filter includes a filter selected from the group consisting of: a plurality of filters, a monochromator, a color-filter array, a liquid crystal tunable filter, and a combination thereof.

28. The apparatus of claim 19, wherein the illumination source includes a plurality of light emitting diodes (LEDS), each LED configured and arranged to emit light in the UV through visible to NIR spectral bands.

29. The apparatus of claim 19, wherein the illumination source includes a wideband illumination source configured and arranged to emit light in the plurality of different spectral bands spanning the fluorescence signal spectrum.

30. An apparatus comprising:
an illumination source configured to illuminate a target by directing a plurality of different illuminants toward the target, the plurality of different illuminants spanning a spectrum;
a photodetector arrangement, including a photodetector circuit, an optical filter and a lens, wherein the optical filter is arranged in an optical path between the photodetector circuit and the target, the filter and the lens being configured to selectively pass light in each of a plurality of different spectral bands to the photodetector circuit, wherein the photodetector circuit is configured to capture intensity characteristics indicative of a fluorophore of the target acquired in the plurality of different spectral bands and under the plurality of different illuminations; and
processing circuitry configured and arranged to:
for each of the different spectral bands, using the captured intensity characteristics to provide component entries that correspond to and characterize fluorescence and reflectance contributions in each of the different spectral bands and in response to the provided component entries, concurrently compute components indicative of reflectance spectra estimation and fluorescence spectra estimation based on the captured intensity characteristics of the selectively passed light in the different spectral bands and based on the computed components having a smoothness function relative to adjacent ones of the different spectral bands;
select, among the concurrently computing components in each of the spectral bands, which ones of the concurrently computed components are likely to be indicative of reflectance spectra estimation and fluorescence spectra estimation for a fluorophore in the target by minimizing a weighted sum of a difference between the captured intensity characteristics and the computed components, a weight of the smoothness function relative to adjacent ones of the different spectral bands, and a weighted nuclear norm of the component entries that correspond to and characterize fluorescence contributions; and
output said reflectance spectra estimation and fluorescence spectra estimation for the fluorophore in the target using the selected components.

31. The apparatus of claim 30, wherein the photodetector circuit is configured and arranged to capture a set of images, using the selectively passed light, that includes the captured intensity characteristics, and wherein the illumination source and optical filter are configured and arranged to selectively insert a single optical filter into the optical path for one of the respective images, thereby only the wavelength transmitted through the optical filter reaches the photodetector circuit and contributes to the sensor response for the respective image.

32. The apparatus of claim 30, wherein the fluorescent properties are generated by more than one fluorophore in the target and the processing circuitry is configured and arranged to output a reflectance spectra estimating and fluorescence spectra estimation for each fluorophore in the target.

33. The apparatus of claim 30, wherein the optical filter includes a color-filter array comprised of a plurality of filters and the illumination source includes a plurality of light emitting diodes (LEDS), each LED configured and arranged to emit light in the UV through visible to NIR spectral bands.

34. The apparatus of claim 30, wherein the optical filter includes a liquid crystal tunable filter and the illumination source includes a plurality of light emitting diodes (LEDS), each LED configured and arranged to emit light in the UV through visible to NIR spectral bands.

35. The apparatus of claim 30, wherein the processing circuitry is configured and arranged to select the concurrently computed components by iteratively minimizing a weighted sum of an error between the captured intensity characteristics and intensities predicted by an image formation model incorporating the computed components, the smoothness function relative to adjacent ones of the different spectral bands, and a weighted nuclear norm of the matrix entries that correspond to and characterize fluorescence contributions.
